(19) United States
(12) Patent Application Publication
(10) Pub. No.: US 2026/0086671 A1
(43) Pub. Date: Mar. 26, 2026

(54) INPUT SENSING DEVICE AND DISPLAY DEVICE INCLUDING THE SAME

(71) Applicant: LG Display Co., Ltd., Seoul (KR)

(72) Inventor: Hyunwoo JANG, Paju-si (KR)

(73) Assignee: LG Display Co., Ltd., Seoul (KR)

(21) Appl. No.: 19/305,154

(22) Filed: Aug. 20, 2025

(30) Foreign Application Priority Data
Sep. 23, 2024 (KR) 10-2024-0128088

(51) Int. Cl. G06F 3/041; G09G 3/20

(52) U.S. Cl. CPC G06F 3/04164; G06F 3/04166; G09G 3/2096; G09G 2300/0814; G09G 2310/0267; G09G 2310/0275; G09G 2310/08; G09G 2330/021

(57) ABSTRACT

An input sensing device and a display device including the same are discussed. The input sensing device includes a touch panel having a plurality of touch electrodes divided into a plurality of sensing groups, a touch driving circuit configured to apply a touch driving signal to the plurality of sensing groups during a touch driving period and sense a touch based on a touch sensing signal received in response to the touch driving signal, and a plurality of multiplexers connected to corresponding sensing groups through a plurality of touch lines and configured to electrically connect the corresponding sensing group to the touch driving circuit in response to a multiplexer control signal and a local selection signal.

### CROSS-REFERENCE TO RELATED APPLICATION

The present application claims priority to Korean Patent Application No. 10-2024-0128088, filed in the Republic of Korea on Sep. 23, 2024, the entire contents of which is hereby expressly incorporated herein for all purposes by reference into the present application.

### BACKGROUND

### Technical Field

The present disclosure relates to an input sensing device and a display device including the same.

### Description of the Related Art

With the development of the information society, various forms of display devices are being developed. Recently, various types of display devices such as liquid crystal display (LCD), plasma display panel (PDP), and organic light emitting display (OLED) are being utilized.

Recently, moving away from conventional input methods such as buttons, keyboards, and mice, display devices equipped with touch screen panels TSPs, capable of detecting touch, hovering, and/or gesture inputs by a user's finger or a stylus pen, have come into widespread use.

These display devices include input sensing devices for detecting the presence of inputs and input coordinates (input position). The input sensing device drives the touch electrodes arranged on the touch screen panel and processes the touch sensing signals output from the touch electrodes through analog front-end circuits. Based on the amplified signals, the input sensing device detects input information such as touch presence and/or touch position.

The input sensing device performs a full scan across the entire touch screen panel and, upon detecting a touch, performs a local scan only for the area where the touch occurred. The local scan can be performed in units of sensing groups composed of one or more touch electrodes.

The description provided in the discussion of the related art section should not be assumed to be prior art merely because it is mentioned in or associated with that section. The discussion of the related art section can include information that describes one or more aspects of the subject technology, and the description in this section does not limit the disclosure.

### SUMMARY OF THE DISCLOSURE

In the aforementioned situation, the inventors of the present disclosure have recognized there can be areas within the sensing group where no actual touch occurs, and performing a local scan across the entire area of the sensing group can lead to unnecessary power consumption.

It is an object of the embodiments of the present disclosure to provide an input sensing device and a display device including the same, capable of performing a full scan when detecting touch input and a local scan when detecting additional touch input.

It is another object of the embodiments of the present disclosure to provide an input sensing device and a display device including the same, capable of driving the touch electrodes connected to the touch driving circuit through multiplexers in units of sensing groups, each connected to a respective multiplexer and including a plurality of touch electrodes.

It is another object of the embodiments of the present disclosure to provide an input sensing device and a display device including the same, capable of controlling the multiplexers to drive only certain touch electrodes within the sensing group during local scan mode.

It is still another object of the embodiments of the present disclosure to provide an input sensing device and a display device including the same, equipped with a multiplexer unit configured to select certain touch electrode columns and/or touch electrode rows within the corresponding sensing group and connect the selected electrodes to the touch driving circuit.

An input sensing device according to an embodiment of the present disclosure can include a touch panel including a plurality of touch electrodes divided into a plurality of sensing groups, a touch driving circuit configured to apply a touch driving signal to the plurality of sensing groups during a touch driving period and sense a touch based on a touch sensing signal received in response to the touch driving signal, and a plurality of multiplexers connected to corresponding sensing groups through a plurality of touch lines and configured to electrically connect the corresponding sensing group to the touch driving circuit in response to a multiplexer control signal and a local selection signal.

According to aspects of the present disclosure, each of the plurality of sensing groups can include a plurality of sensing units including one or more touch electrodes, and each of the plurality of multiplexers can be configured to electrically connect all or some of the plurality of sensing units of the corresponding sensing group to the touch driving circuit in response to the local selection signal during the touch driving period.

According to aspects of the present disclosure, each of the plurality of multiplexers can include a first switching unit configured to control a connection between the plurality of touch lines and the touch driving circuit based on the multiplexer control signal and the local selection signal, and a second switching unit configured to control a connection between a common voltage and the touch lines based on an output signal of the first switching unit.

According to aspects of the present disclosure, the first switching unit can include first logic gates configured to output a first logic signal at a logic high level based on the local selection signal being at a turn-on level, second logic gates configured to output a second logic signal at a logic high level based on both the first logic signal and the multiplexer control signal being at a turn-on level, and switching elements configured to turn on and electrically connect a corresponding touch line to the touch driving circuit based on the second logic signal being at a logic high level.

According to aspects of the present disclosure, the local selection signal can include a plurality of local signals indicating each of the plurality of sensing units, and a local all signal (also referred to herein as a local-all-signal) indicating all of the plurality of sensing units.

According to aspects of the present disclosure, each of the first logic gates can be an OR gate configured to receive a corresponding local signal and the local all signal and output the first logic signal at a logic high level based on at least one of the corresponding local signal and the local all signal being at the turn-on level.

According to aspects of the present disclosure, in one of two multiplexers respectively connected to two adjacent sensing groups, the first switching unit can further include first inverting logic gates configured to invert the logic level of the corresponding local signal and apply the inverted logic level to the first logic gates.

According to aspects of the present disclosure, the plurality of local signals can include at least one of a plurality of local column signals each indicating one or more touch electrode columns and a plurality of local row signals each indicating one or more touch electrode rows.

According to aspects of the present disclosure, the first logic gates can include first-first logic gates configured to output a first-first logic signal at a logic high level based on both the corresponding local row signal and the corresponding local column signal being at the turn-on level, and first-second logic gates configured to output a first-second logic signal at a logic high level based on both the first-first logic signal and the local all signal being at the turn-on level.

According to aspects of the present disclosure, each of the first-first logic gates can be an AND gate configured to receive the corresponding local row signal and the corresponding local column signal, and output the first-first logic signal at a logic high level based on both the corresponding local row signal and the corresponding local column signal being at the turn-on level.

According to aspects of the present disclosure, in one of two multiplexers connected to two adjacent sensing groups, the first switching unit can further include second inverting logic gates configured to invert the logic level of the corresponding local row signal and apply the inverted logic level to the first-first logic gates.

According to aspects of the present disclosure, each of the first-second logic gates can be OR gate configured to receive the first-first logic signal and the local all signal, and output the first-second logic signal at a logic high level based on at least one of the first-first logic signal and the local all signal being at the turn-on level.

According to aspects of the present disclosure, each of the second logic gates can be an AND gate configured to receive the first logic signal and the multiplexer control signal, and output the second logic signal at a logic high level based on both the first logic signal and the multiplexer control signal being at the turn-on level.

According to aspects of the present disclosure, each of the switching elements can be a transistor connected between the corresponding touch line and the touch driving circuit and including a gate electrode configured to receive the second logic signal.

According to aspects of the present disclosure, in a full scan mode, the multiplexer control signals at the turn-on level can be sequentially applied to the plurality of multiplexers, and in a local scan mode, the multiplexer control signal at the turn-on level can be applied to at least one multiplexer corresponding to the sensed touch.

According to aspects of the present disclosure, based on the touch being sensed in one sensing group, the local all signal at the turn-on level can be further applied to the multiplexer connected to the one sensing group in the local scan mode.

According to aspects of the present disclosure, based on the touch being sensed in two or more adjacent sensing groups, the local all signal at a turn-off level can be further applied to the multiplexers connected to the two or more sensing groups, and the local signal at a turn-on level can be further applied corresponding to the at least one sensing unit where the touch is sensed.

A display device according to an embodiment of the present disclosure can include a display panel including a plurality of pixels, a data driving circuit configured to apply data voltage to the plurality of pixels, a scan driving circuit configured to apply gate signals to the plurality of pixels, a timing controller configured to control operation timings of the data driving circuit and the scan driving circuit, a touch panel arranged, overlapping the display panel, and including touch electrodes and divided into a plurality of sensing groups, a touch driving circuit configured to apply a touch driving signal to the plurality of sensing groups during a touch driving period and sense a touch based on a touch sensing signal received in response to the touch driving signal, and a plurality of multiplexers connected to corresponding sensing groups through a plurality of touch lines and configured to electrically connect the corresponding sensing groups to the touch driving circuit in response to multiplexer control signals and local selection signals.

According to aspects of the present disclosure, each of the plurality of sensing groups can include a plurality of sensing units including one or more touch electrodes, and each of the plurality of multiplexers can be configured to electrically connect all or some of the plurality of sensing units of the corresponding sensing group to the touch driving circuit in response to the local selection signal during the touch driving period.

According to aspects of the present disclosure, each of the plurality of multiplexers can include a first switching unit configured to control a connection between the plurality of touch lines and the touch driving circuit based on the multiplexer control signal and the local selection signal, and a second switching unit configured to control a connection between a common voltage and the touch lines based on an output signal of the first switching unit.

According to aspects of the present disclosure, the first switching unit can include first logic gates configured to output a first logic signal at a logic high level based on the local selection signal being at a turn-on level, second logic gates configured to output a second logic signal at a logic high level based on both the first logic signal and the multiplexer control signal being at a turn-on level, and switching elements configured to turn on and electrically connect a corresponding touch line to the touch driving circuit based on the second logic signal being at a logic high level.

According to aspects of the present disclosure, the local selection signal can include a plurality of local signals indicating respective ones of the plurality of sensing units, and a local all signal indicating all of the plurality of sensing units.

Other systems, methods, features and advantages will be, or will become, apparent to one with skill in the art upon examination of the following figures and detailed description. It is intended that all such additional systems, methods, features and advantages be included within this description, be within the scope of the present disclosure. Further aspects and advantages are discussed below in conjunction with embodiments of the disclosure.

It is to be understood that both the foregoing general description and the following detailed description are examples and explanatory, and are intended to provide further explanation of the inventive concepts as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a block diagram illustrating a configuration of a display device according to one or more embodiments of the present disclosure;

FIG. 2 is a diagram illustrating the configuration of an input sensing device according to one or more embodiments of the present disclosure;

FIG. 3 is a timing diagram illustrating the driving signals of the touch panel shown in FIG. 2;

FIG. 4 is a diagram illustrating the connection relationship between the touch panel and the touch driving circuit according to one embodiment of the present disclosure;

FIG. 5 is a diagram illustrating the connection relationship between the touch electrodes, multiplexers, and the touch driving circuit shown in FIG. 4 in more detail;

FIG. 6 is a state transition diagram illustrating the driving method of the input sensing device during the touch driving period;

FIG. 7 is a timing diagram illustrating the driving method of the multiplexer unit in each driving mode shown in FIG. 6;

FIGS. 8 to 10 illustrate cases where a touch occurs according to various embodiments of the present disclosure;

FIGS. 11A and 11B are diagrams illustrating the configuration of the multiplexer unit according to a first embodiment of the present disclosure;

FIG. 12 is a timing diagram illustrating the driving signals of the multiplexer unit according to the embodiment of FIGS. 11A and 11B;

FIG. 13 is a diagram illustrating the driving state of the touch panel according to the driving signals shown in FIG. 12;

FIG. 14 is a timing diagram illustrating the driving signals of the multiplexer unit according to the embodiment of FIGS. 11A and 11B;

FIG. 15 is a diagram illustrating the driving state of the touch panel according to the driving signals shown in FIG. 14;

FIGS. 16A and 16B are diagrams illustrating the configuration of the multiplexer unit according to a second embodiment of the present disclosure;

FIG. 17 is a timing diagram illustrating the driving signals of the multiplexer unit according to the embodiment of FIGS. 16A and 16B;

FIG. 18 is a diagram illustrating the driving state of the touch panel according to the driving signals shown in FIG. 17;

FIGS. 19A and 19B are diagrams illustrating the configurations of the multiplexer unit according to a third embodiment of the present disclosure;

FIG. 20 is a timing diagram illustrating the driving signals of the multiplexer unit according to the embodiment of FIGS. 19A and 19B; and

FIG. 21 is a diagram illustrating the driving state of the touch panel according to the driving signals shown in FIG. 20.

Throughout the drawings and the detailed description, unless otherwise described, the same drawing reference numerals should be understood to refer to the same elements, features, and structures. The relative size and depiction of these elements can be exaggerated for clarity, illustration, and convenience.

### DETAILED DESCRIPTION OF THE EMBODIMENTS

Hereinafter, embodiments of the present disclosure will be described with reference to accompanying drawings. In the specification, when a component (or area, layer, part, etc.) is mentioned as being “on top of,” “connected to,” or “coupled to” another component, it means that it can be directly connected/coupled to the other component, or a third component can be placed between them.

The same reference numerals refer to the same components. In addition, in the drawings, the thickness, proportions, and dimensions of the components are exaggerated for effective description of the technical content. The expression “and/or” is taken to include one or more combinations that can be defined by associated components.

The terms “first,” “second,” etc. are used to describe various components, but the components should not be limited by these terms. The terms are used only for distinguishing one component from another component and may not define order or sequence. For example, a first component can be referred to as a second component and, similarly, the second component can be referred to as the first component, without departing from the scope of the present disclosure. The singular forms are intended to include the plural forms as well unless the context clearly indicates otherwise.

The terms such as “below,” “lower,” “above,” “upper,” etc. are used to describe the relationship of components depicted in the drawings. The terms are relative concepts and are described based on the direction indicated on the drawing.

It will be further understood that the terms “comprises,” “has,” and the like are intended to specify the presence of stated features, numbers, steps, operations, components, parts, or a combination thereof but are not intended to preclude the presence or possibility of one or more other features, numbers, steps, operations, components, parts, or combinations thereof.

In the following description, when a detailed description of well-known functions or configurations related to this document is determined to unnecessarily cloud a gist of the inventive concept, the detailed description thereof will be omitted or can be briefly discussed.

Advantages and features of the present disclosure, and implementation methods thereof will be clarified through following example embodiments described with reference to the accompanying drawings. The present disclosure may, however, be embodied in different forms and should not be construed as limited to the example embodiments set forth herein. Rather, these example embodiments can be provided so that this disclosure can be sufficiently thorough and complete to assist those skilled in the art to fully understand the scope of the present disclosure.

Any implementation described herein as an “example” is not necessarily to be construed as preferred or advantageous over other implementations.

In addition, when any dimensions, relative sizes etc. are mentioned, it should be considered that numerical values for an elements or features, or corresponding information (e.g., level, range, etc.) include a tolerance or error range that can be caused by various factors (e.g., process factors, internal or external impact, noise, etc.) even when a relevant description is not specified. Further, the term “can” fully encompasses all the meanings of the term “may” and vice versa.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning, for example, consistent with their meaning in the context of the relevant art and should not be interpreted in an idealized or overly formal sense unless expressly so defined herein. For example, the term “part” or “unit” can apply, for example, to a separate circuit or structure, an integrated circuit, a computational block of a circuit device, or any structure configured to perform a described function as should be understood to one of ordinary skill in the art.

Rather, these embodiments of the present disclosure can be provided so that this disclosure can be sufficiently thorough and complete to assist those skilled in the art to fully understand the scope of the present disclosure. All the components of each display device according to all embodiments of the present disclosure are operatively coupled and configured.

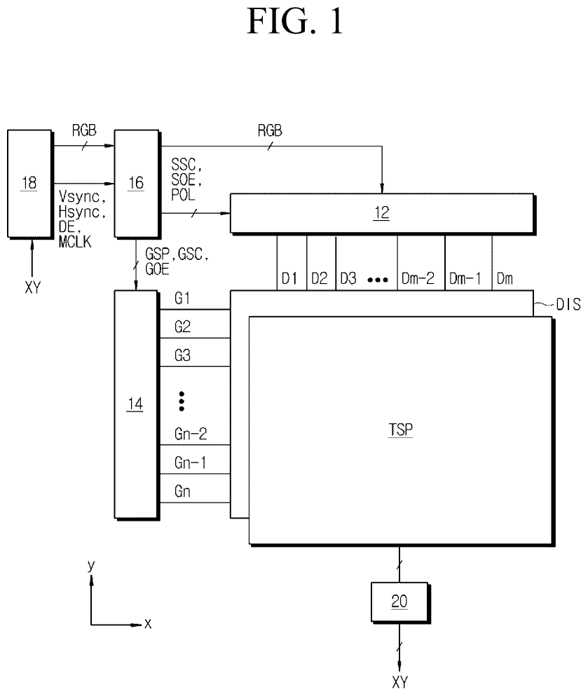

FIG. 1 is a block diagram illustrating a configuration of a display device according to one or more embodiments of the present disclosure.

Referring to FIG. 1, the display device according to an embodiment of the present disclosure can include a driving circuit and a display panel DIS.

The driving circuit is for controlling the emission of light from the pixels disposed on the display panel DIS and includes a data driving circuit 12, a scan driving circuit 14, and a timing controller 16.

The data driving circuit 12 converts the digital video data RGB output from the timing controller 16 into analog voltages, generating data voltages. The data driving circuit 12 provides the generated data voltages to the pixels of the display panel DIS through a plurality of data lines D1 to Dm.

The scan driving circuit 14 can sequentially supply gate pulses (or scan pulses) synchronized with the data voltages to the gate lines G1 to Gn.

The timing controller 16 controls the operating timing of the data driving circuit 12 and the scan driving circuit 14 based on timing signals such as vertical sync signal Vsync, horizontal sync signal Hsync, data enable signal DE, and main clock MCLK input from the host system 18.

The timing controller 16 generates data timing control signals based on the timing signals and applies them to the data driving circuit 12. The data timing control signals include source sampling clock SSC, polarity control signals POL, source output enable signals SOE, etc.

The timing controller 16 generates scan timing control signals based on the timing signals and applies them to the scan driving circuit 14. The scan timing control signals include gate start pulse GSP, gate shift clock GSC, and gate output enable signals GOE, etc.

The host system 18 can be a television, set-top box, navigation system, DVD player, Blu-ray player, personal computer PC, home theater, phone system, etc., but is not limited thereto. The host system 18 can include a System on Chip (SoC) with a scaler to convert the digital video data (RGB) of the input image into a format suitable for display on the display panel DIS. The host system 18 transmits the digital video data along with timing signals Vsync, Hsync, DE, and MCLK to the timing controller 16. Additionally, the host system 18 can execute an application associated with coordinate information XY received from the touch driving circuit 20.

The display panel DIS includes a plurality of pixels (also referred to as sub-pixels). The pixels, for example, can be arranged in a matrix form on the display panel DIS. Pixels arranged in a single pixel row are connected to the same gate line G1 to Gn, and pixels arranged in a single pixel column are connected to the same data line D1 to Dm. Pixels can emit light at a luminance corresponding to the gate pulses and data voltages supplied through the gate lines G1 to Gn and data lines D1 to Dm.

In an embodiment of the present disclosure, each pixel can display one of the colors red, green, or blue. Alternatively, each pixel can display one of the colors cyan, magenta, or yellow. Alternatively, each pixel can display one of the colors red, green, blue, or white.

In an embodiment of the present disclosure, the display device can include an input sensing device. The input sensing device can include a touch panel TSP and a touch driving circuit 20.

The touch panel TSP is disposed to overlap with the display panel DIS and can be configured as an external (Add-On) type attached on top of the display panel DIS or as an internal (In-Cell or On-Cell) type embedded between layers of the display panel DIS.

The touch panel TSP includes touch electrodes and touch lines connected to the touch electrodes. The touch electrodes are electrically connected to the touch driving circuit 20 via the touch lines. Each touch electrode receives a touch driving signal from the touch driving circuit 20 through its corresponding touch line and, in response, outputs a touch sensing signal to the touch driving circuit 20.

The touch driving circuit 20 senses changes in capacitance at the touch electrodes to determine whether a conductive material, such as a finger, has caused an input and to identify the input position. The touch driving circuit 20 applies the touch driving signal to the touch electrodes through the touch lines and receives the touch sensing signals output from the touch lines.

When it is determined, based on the touch sensing signal, that the capacitance change of the touch electrodes exceeds a threshold value, indicating that an input has occurred, the touch driving circuit 20 transmits a touch report, including the input's coordinate information (XY), to the host system 18.

The touch driving circuit 20 can be implemented independently or integrated with the data driving circuit 12 in one or more integrated circuits.

In an embodiment of the present disclosure, the display device can be a rigid display device or a flexible display device. For example, the display device can be a foldable display device, a bendable display device, a rollable display device, or a stretchable display device.

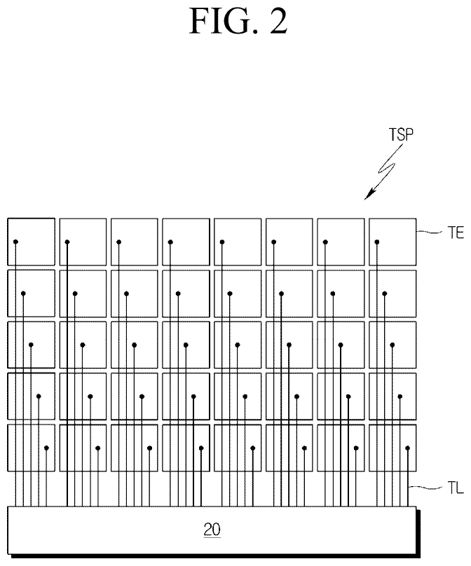

FIG. 2 is a diagram illustrating the configuration of an input sensing device according to one embodiment of the present disclosure.

In the embodiment of FIG. 2, the input sensing device can provide a self-capacitance-based touch sensing function that detects touch input by measuring the capacitance or changes in capacitance formed at each touch electrode TE. In this embodiment, the input sensing device can include a touch panel TSP and a touch driving circuit 20.

Referring to FIG. 2, the touch panel TSP can have multiple touch electrodes TE. Each touch electrode TE can receive a touch driving signal and output a touch sensing signal. Each of the multiple touch electrodes TE can be electrically connected to the touch driving circuit 20 via one or more touch lines TL.

The area where a touch electrode TE is formed can correspond to or be larger than the area where a pixel is formed. For example, a single touch electrode TE can be formed to overlap with two or more pixels. However, this embodiment is not limited thereto.

Meanwhile, FIG. 2 exemplifies a self-capacitance-based touch panel TSP that detects touch input by measuring the capacitance or changes in capacitance formed at each touch electrode TE. However, this embodiment is not limited thereto. In various other embodiments of the present disclosure, the touch panel TSP can provide a mutual-capacitance-based touch sensing function, which detects touch input by measuring the capacitance or changes in capacitance formed between two types of touch electrodes (e.g., Tx and Rx electrodes).

The touch driving circuit 20 is electrically connected to the touch electrodes TE via the touch lines TL. During a touch driving period in which touch sensing is performed, the touch driving circuit 20 can supply a touch driving signal to the touch panel TSP. The touch driving signal can take various forms, such as a square-wave pulse, a sine wave, or a triangular wave. The touch driving circuit 20 can determine the presence and/or position of a touch input based on the touch sensing signals received (or detected) from the touch electrodes TE in response to the touch driving signal.

In an embodiment of the present disclosure, the touch driving circuit 20 can be configured to apply a predetermined voltage, such as a common voltage, to the touch electrodes TE during a display driving period in which images are displayed through pixels. Applying a stable DC voltage to the touch electrodes TE can prevent or reduce noise generation from the touch electrodes TE to the display panel DIS (FIG. 1) during the display driving period.

The driving method of the input sensing device using the touch driving circuit 20 is described in detail below.

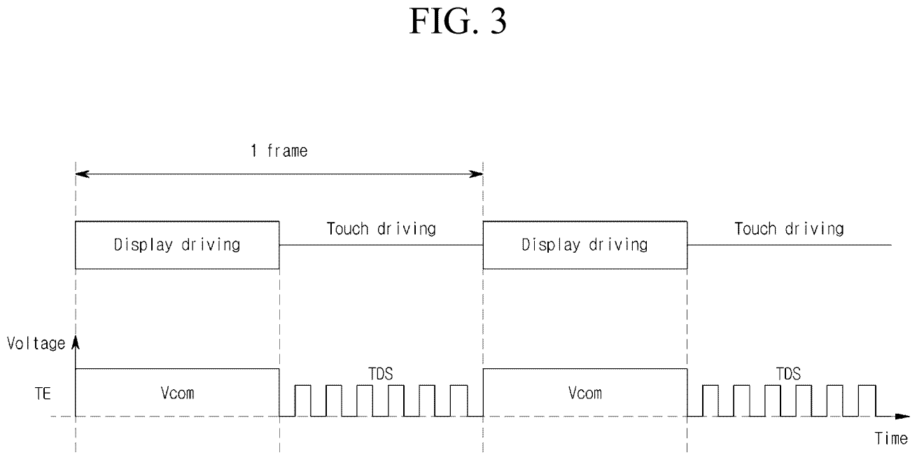

FIG. 3 is a timing diagram illustrating the driving signals of the touch panel shown in FIG. 2.

Referring to FIG. 3, a frame for driving the display device according to an embodiment can include a display driving period and a touch driving period. The display driving period and the touch driving period can be time-divisioned within a frame.

Referring to FIGS. 2 and 3 together, during the display driving period, the touch driving circuit 20 can apply a common voltage Vcom to all touch electrodes TE through all touch lines TL.

During the touch driving period following the display driving period, the touch driving circuit 20 can apply a touch driving signal TDS to the touch electrodes TE through the touch lines TL. As illustrated, the touch driving signal TDS can be a pulse signal in the form of a square wave, but is not limited thereto and can have various forms such as a sine wave or a triangular wave.

The touch driving circuit 20 can be connected to the touch electrodes TE through the touch lines TL and can be configured to selectively apply either the common voltage Vcom or the touch driving signal TDS to the touch electrodes TE. For this purpose, the touch driving circuit 20 can include at least one switching element and/or logic element.

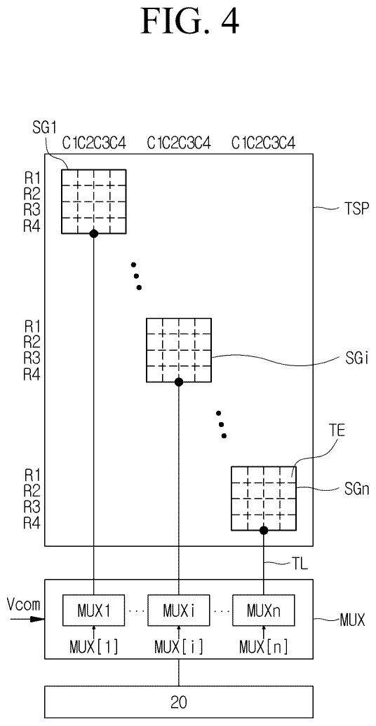

FIG. 4 is a diagram illustrating the connection relationship between the touch panel and the touch driving circuit according to one embodiment of the present disclosure.

Referring to FIG. 4, the input sensing device can include a touch panel TSP, a touch driving circuit 20 connected to the touch panel TSP, and a multiplexer MUX that connects the touch panel TSP and the touch driving circuit 20.

The touch panel TSP includes touch electrodes TE that are divided into n sensing groups SG1 to SGn, where n is a natural number greater than 1. The sensing group SG1 to SGn each include m touch electrodes TE, where m is a natural number greater than 1. In FIG. 4, i is a natural number greater than 1 and less than n.

Additionally, the touch panel TSP includes touch lines TL that connect each touch electrode TE to the multiplexer MUX. FIG. 4 shows only one touch line TL connected to sensing groups SG1 to Sgn for convenience of explanation. However, the m touch electrodes TE included in each of the sensing groups SG1 to SGn can be connected to m touch lines TL, respectively.

The m touch electrodes TE in a single sensing groups SG1 to SGn can be arranged in a matrix form within the sensing group SG1 to SGn. For example, a sensing group SG1 to SGn can include a plurality of touch electrode rows R1 to R4 and touch electrode columns C1 to C4.

In the embodiment, 16 touch electrodes TE are included in a sensing group SG1 to SGn. Additionally, one sensing group SG1 to SGn can be composed of 4 touch electrode rows R1 to R4 and 4 touch electrode columns C1 to C4. The 16 touch electrodes TE can be connected to 16 touch lines TL, respectively. However, this embodiment is not limited thereto.

In an embodiment of the present disclosure, each sensing group SG1 to SGn can generally be rectangular. However, this embodiment is not limited thereto, and the shape of the sensing groups SG1 to SGn can be selected in various ways.

When each of the sensing groups SG1 to SGn is generally rectangular, the sensing groups SG1 to SGn can be arranged in a matrix form on the touch panel TSP. For example, the touch panel TSP can include a plurality of sensing group rows and a plurality of sensing group columns.

The multiplexer unit MUX can include n multiplexers MUX1 to MUXn. Here, the multiplexers MUX1 to MUXn are conceptually distinguished as switching elements and/or logic elements included in the multiplexer unit MUX, but they may not be physically distinct components.

Each multiplexer MUX1 to MUXn can be connected to the corresponding sensing group SG1 to SGn. For example, the multiplexers MUX1 to MUXn and the sensing groups SG1 to SGn can be connected in a 1:1 configuration.

Each multiplexer MUX1 to MUXn can be electrically connected to the touch electrodes TE in the corresponding sensing group SG1 to SGn through the touch lines TL. As illustrated, when a sensing group SG1 to SGn consists of 16 touch electrodes TE, one of the multiplexers MUX1 to MUXn can be connected to the touch electrodes TE via 16 touch lines TL.

The multiplexers MUX1 to MUXn can be electrically connected to the touch driving circuit 20. The touch electrodes TE can be connected to the touch driving circuit 20 through the corresponding multiplexer MUX1 to MUXn.

In this embodiment, each multiplexer MUX1 to MUXn can be a 1:m multiplexer that connects m touch electrodes TE to one touch driving circuit 20. As illustrated, when a sensing group SG1 to SGn consists of 16 touch electrodes TE, each multiplexer MUX1 to MUXn can be a 1:16 multiplexer that connects the 16 touch electrodes TE to one touch driving circuit 20.

The multiplexers MUX1 to MUXn can be configured to receive corresponding mux control signals MUX[1] to MUX[n]. For example, the first multiplexer MUX1 can receive the first mux control signal MUX[1], and the second multiplexer MUX2 can receive the second mux control signal MUX[2]. The multiplexers MUX1 to MUXn can respond to the turn-on level of the mux control signals MUX[1] to MUX[n] to electrically connect the touch electrodes TE in the corresponding sensing group SG1 to SGn with the touch driving circuit 20.

The multiplexers MUX1 to MUXn can divide the touch electrodes TE in the corresponding sensing groups SG1 to SGn into predetermined sensing units, and connect all or some of the sensing units to the touch driving circuit 20. A sensing unit can consist of one or more touch electrodes TE. For example, a sensing unit can consist of one or more touch electrode columns C1 to C4 or one or more touch electrode rows R1 to R4. In this embodiment, the multiplexers MUX1 to MUXn can connect all or selected ones of the touch electrode columns C1 to C4 to the touch driving circuit 20, or all or selected ones of the touch electrode rows R1 to R4 to the touch driving circuit 20.

The touch driving circuit 20 is connected to the touch electrodes TE via the multiplexer MUX. The touch driving circuit 20 can apply a common voltage Vcom (FIG. 2) or a touch driving signal TDS (FIG. 2) to the connected touch electrodes TE, and can receive touch sensing signals output from the touch electrodes TE.

In an embodiment of the present disclosure, the touch driving circuit 20 can operate in either a full scan mode, in which touch is scanned across all sensing groups SG1 to SGn, or a local scan mode, where touch is scanned for only a selected subset of sensing groups SG1 to SGn.

In the full scan mode, all multiplexers MUX1 to MUXn are sequentially turned on through the mux control signals MUX[1] to MUX[n], and the touch driving circuit 20 can apply the touch driving signal TDS to the touch electrodes TE through the turned-on multiplexers MUX1 to MUXn. Based on the touch sensing signals received through each multiplexer MUX1 to MUXn, the touch driving circuit 20 can identify the approximate location where the touch occurred, i.e., the sensing group SG1 to SGn where the touch occurred.

In the local scan mode, at least one selected multiplexer MUX1 to MUXn is turned on via the mux control signals MUX[1] to MUX[n], and the touch driving circuit 20 applies the touch driving signal TDS to the touch electrodes TE through the turned-on multiplexer MUX1 to MUXn. Based on the touch sensing signals received from the multiplexers MUX1 to MUXn, the touch driving circuit 20 can identify the detailed location of the touch within the sensing group SG1 to SGn.

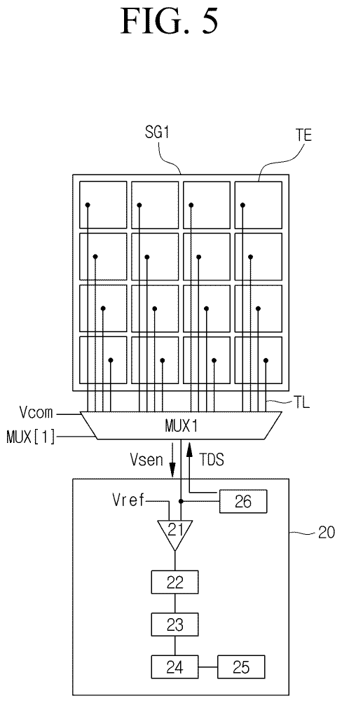

FIG. 5 is a diagram illustrating the connection relationship between the touch electrodes, multiplexers, and the touch driving circuit shown in FIG. 4 in more detail. Particularly, FIG. 5 illustrates the connection relationship between the touch electrodes TE included in the first sensing group SG1, the first multiplexer MUX1, and the touch driving circuit 20, shown representatively for convenience of explanation.

Referring to FIG. 5, a plurality of touch electrodes TE can be included in the first sensing group SG1. For example, the first sensing group SG1 can include 16 touch electrodes TE arranged in a matrix form. In this embodiment, the first sensing group SG1 can consist of 4 touch electrode rows R1 to R4 and 4 touch electrode columns C1 to C4. The touch electrodes TE are electrically connected to the first multiplexer MUX1 through touch lines TL.

The first multiplexer MUX1 is electrically connected to the touch electrodes TE in the first sensing group SG1 via the touch lines TL. The first multiplexer MUX1 can be configured to electrically connect the touch electrodes TE in the first sensing group SG1 to the touch driving circuit 20 in response to the first mux control signal MUX[1].

The first multiplexer MUX1 can receive the common voltage Vcom from an external power management circuit. Additionally, the first multiplexer MUX1 can include switching elements that connect the touch electrodes TE either to the common voltage Vcom or to the touch driving circuit 20. The switching elements can connect the touch lines TL to the touch driving circuit 20 when the first mux control signal MUX[1] is at the turn-on level, and connect the touch lines TL to the input terminal of the common voltage Vcom when the first mux control signal MUX[1] is at the turn-off level.

The touch driving circuit 20 can include an operational amplifier 21, an integrator circuit 22, a sampling and hold circuit 23, an analog-to-digital converter 24, a controller 25, and a touch driving signal generation circuit 26.

The operational amplifier 21 can receive the sensing signal Vsen input from the touch electrodes TE via the first multiplexer MUX1. Additionally, the operational amplifier 21 can receive a reference signal Vref. By amplifying the voltage difference between the sensing signal Vsen and the reference signal Vref, the operational amplifier 21 can output a signal corresponding to the change in capacitance of the touch electrodes TE.

The integrator circuit 22 can integrate the signal output from the operational amplifier 21 for a predetermined number of integration cycles and output the integrated value.

The sampling and hold circuit 23 can sample and store the integrated value output from the integrator circuit 22.

The analog-to-digital converter 24 can read the stored integrated value from the sampling and hold circuit 23 and output a digital value corresponding to the integrated value. The output digital value is input to the controller 25.

The controller 25 can calculate the presence or absence of a touch and/or the touch position using the digital value input from the analog-to-digital converter 24. The controller 25 can be implemented as a microcontroller unit MCU, processor, etc.

The touch driving signal generation circuit 26 can generate a square wave form of the touch driving signal TDS. The touch driving signal TDS generated by the touch driving signal generation circuit 26 can be provided to the touch electrodes TE via the first multiplexer MUX1. The output path of the touch driving signal TDS and the input path of the touch sensing signal Vsen can be selectively driven via switching elements or the like.

Alternatively, the touch driving signal TDS can be input to one input terminal of the operational amplifier 21 and output to the first multiplexer MUX1 via the other input terminal. However, the embodiment is not limited thereto.

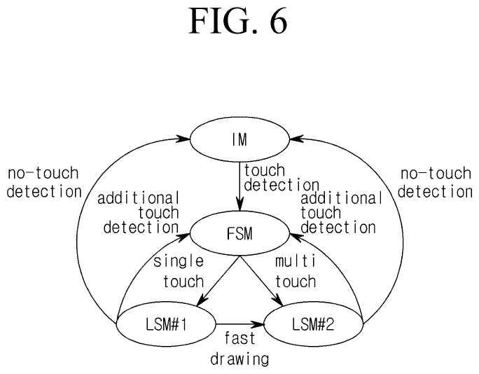

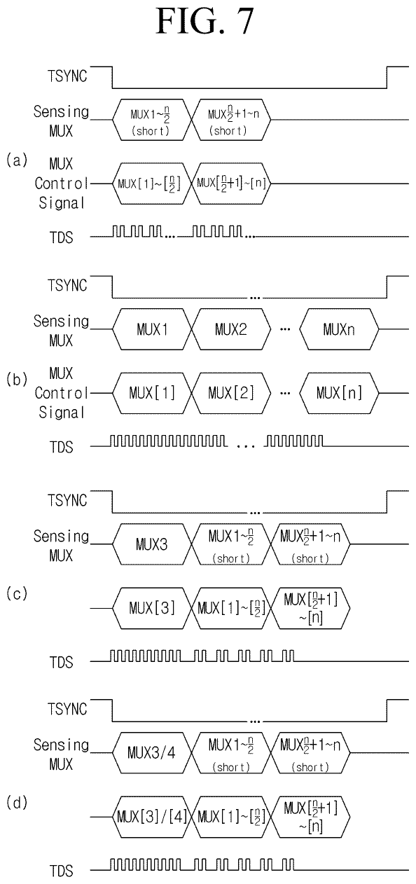

FIG. 6 is a state transition diagram illustrating the driving method of the input sensing device during the touch driving period. FIG. 7 is a timing diagram illustrating the driving method of the multiplexer unit in each driving mode shown in FIG. 6.

Referring to FIG. 6, the input sensing device can operate in a touch driving mode synchronized with the low period of the touch sync signal TSYNC. During the touch driving period, the input sensing device can operate in an idle mode IM. In the idle mode IM, the input sensing device can perform a pre-scan for fast touch sensing on all sensing groups SG1 to SGn.

With reference to (a) of FIG. 7, the touch driving circuit 20 can simultaneously drive some of the multiplexers MUX1 to MUXn/2 to apply the touch driving signal TDS to the corresponding sensing groups SG1 to SGn/2, and determine whether a touch event has occurred through the touch sensing signal. Additionally, the touch driving circuit 20 can simultaneously drive a portion of the multiplexers MUX1 to MUXn (MUXn/2+1 to MUXn) to apply the touch driving signal TDS to the corresponding sensing groups SGn/2+1 to SGn and determine whether a touch occurs through the touch sensing signal.

Here, the touch driving signal TDS applied to each sensing group SG1 to SGn can be a square wave signal with the first number of pulses as shown in (a) of FIG. 7. The first number of pulses is set to the minimum required to determine touch occurrence, allowing a high-speed scan of all sensing groups SG1 to SGn in a short time. The touch driving circuit 20 can determine whether a touch has occurred on the touch panel TSP through the pre-scan.

When a touch is detected in idle mode IM, the input sensing device can operate in a full scan mode FSM. In the full scan mode FSM, the input sensing device can perform a full scan for touch sensing across all sensing groups SG1 to SGn.

Specifically, with reference to (b) of FIG. 7, the touch driving circuit 20 can sequentially drive all multiplexers MUX1 to MUXn to sequentially apply the touch driving signal TDS to the sensing groups SG1 to SGn. Then, the touch driving circuit 20 can identify the sensing group SG1 to SGn where the touch occurred through the touch sensing signal.

In this case, the touch driving signal TDS applied to each sensing group SG1 to SGn can be a square wave signal with a second number of pulses, as shown in (b) of FIG. 7. Here, the second number of pulses is set to be larger than the first number of pulses, allowing for more accurate identification of the touch location. The touch driving circuit 20 can determine the approximate location (the sensing group SG1 to SGn where the touch occurred) and the number of touches, based on the touch sensing signal received in response to the touch driving signal TDS.

Once the sensing group SG1 to SGn where the touch occurred is identified through the full scan mode FSM, the input sensing device can operate in the local scan mode LSM. In the local scan mode LSM, the input sensing device can perform a local scan to sense touch only in the sensing group SG1 to SGn where the touch occurred.

Specifically, the touch driving circuit 20 can select at least one multiplexer MUX1 to MUXn connected to the sensing group SG1 to SGn where the touch occurred, and apply a turn-on level of the mux control signal MUX[1] to MUX[n] to the selected at least one multiplexer MUX1 to MUXn. For example, when a touch occurs in the touch electrode TE of the third sensing group SG3, the touch driving circuit 20 can apply the turn-on level of the mux control signal MUX[3] to the third multiplexer MUX3 and apply the touch driving signal TDS to the third sensing group SG3 via the third multiplexer MUX3. The touch driving circuit 20 can determine the precise location (coordinates) of the touch based on the touch sensing signal received in response to the touch driving signal TDS.

Here, the touch driving signal TDS can be a square wave signal having the second number of pulses, as shown in (c) or (d) of FIG. 7. The touch driving signal TDS applied here can be the same as the touch driving signal TDS applied in a full scan mode FSM.

In an embodiment of the present disclosure, when a single touch is detected through the full scan mode (FSM), the input sensing device can operate in the first local scan mode LSM #1, and when a multi-touch (e.g., multiple touches) is detected, the input sensing device can operate in the second local scan mode LSM #2.

The local scan operation of the input sensing device in the first local scan mode LSM #1 is as described above. In the second local scan mode LSM #2, the input sensing device can perform the aforementioned local scan for each of the multiple touches. The local scan operation for each touch in the second local scan mode LSM #2 is as described above.

During the local scan mode LSM, a pre-scan can be performed after the local scan. After the local scan, the input sensing device can determine the occurrence of additional touches and/or fast drawing touches through a pre-scan, as in idle mode IM. In an embodiment of the present disclosure, the pre-scan in local scan mode LSM can be performed only on the sensing groups SG1 to SGn around the area where the touch has occurred, but this is not limited thereto.

When additional touches are detected or fast-drawing touches are detected through the pre-scan, the input sensing device can operate in a full scan mode FSM or the second local scan mode LSM #2. When no additional touches are detected through the pre-scan, the input sensing device can return to idle mode IM.

The above embodiments disclose that the number of pulses of the touch driving signal TDS is adjusted in the pre-scan, full scan, and local scan modes. However, this embodiment is not limited thereto. For example, in other embodiments of the present disclosure, the touch driving circuit 20 can enable low-power, high-speed scanning during a pre-scan by controlling the voltage of the pulses (pulse size) to be lower than those used in the full scan or local scan modes.

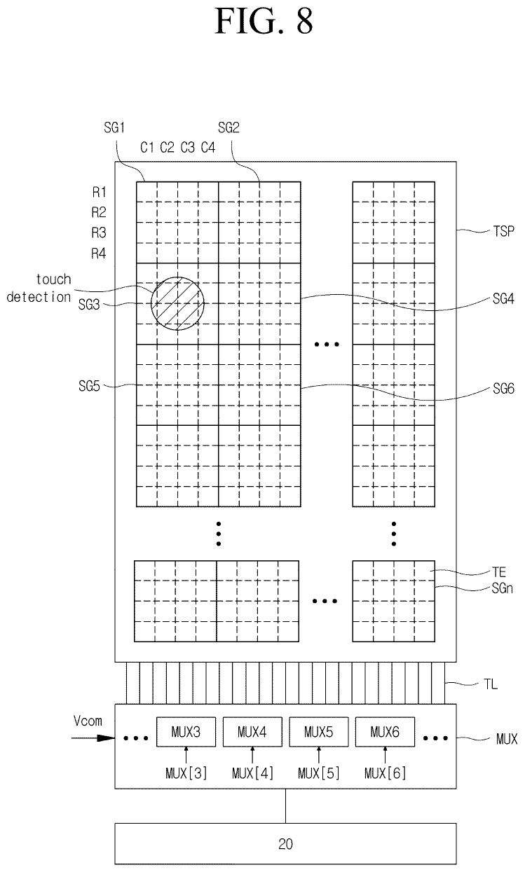

FIGS. 8 to 10 illustrate cases where a touch occurs, showing different scenarios based on various embodiments of the present disclosure.

In the driving method in FIG. 7, when a single touch occurs within a single sensing group SG1 to SGn, only one multiplexer MUX1 to MUXn is turned on during local scan mode LSM, and local scanning is performed for only that sensing group SG1 to SGn. For example, as shown in FIG. 8, when a single touch occurs within the third sensing group SG3, the third multiplexer MUX3 is turned on during local scan mode LSM, and the third sensing group SG3 connected to the third multiplexer MUX3 is scanned.

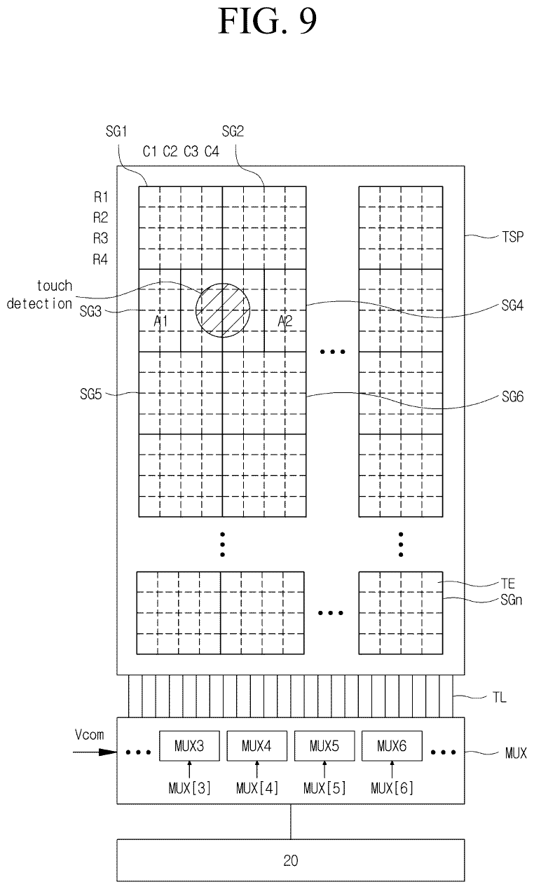

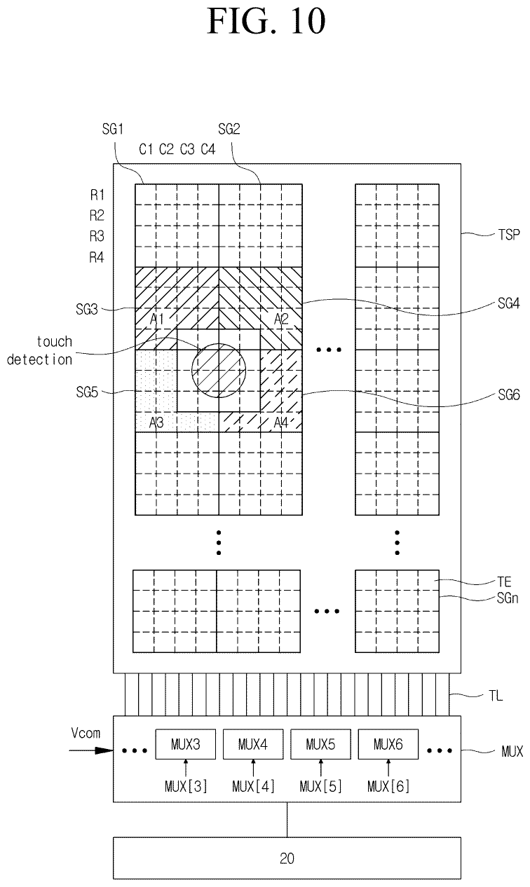

On the other hand, when a single touch occurs at the boundary between two sensing groups SG1 to SGn, two multiplexers MUX1 to MUXn are sequentially turned on during local scan mode LSM, and local scanning is performed for the two sensing groups SG1 to SGn. For example, as shown in FIG. 9, when a single touch occurs at the boundary between the third sensing group SG3 and the fourth sensing group SG4, the third multiplexer MUX3 and the fourth multiplexer MUX4 are turned on during local scan mode LSM, and the third sensing group SG3 and the fourth sensing group SG4 connected to the third multiplexer MUX3 and the fourth multiplexer MUX4 are scanned. Furthermore, as shown in FIG. 10, when a single touch occurs at the boundary between the third to sixth sensing groups SG3 to SG6, the third through sixth multiplexers MUX3 to MUX6 are turned on during local scan mode LSM, and the third through sixth sensing groups SG3 to SG6 connected to the third through sixth multiplexers MUX3 to MUX6 are scanned.

In these embodiments, areas A1, A2, A3, and A4 where no actual touch occurs exist within each sensing group SG1 to SGn. Therefore, scanning all the touch electrodes TEs arranged in the plurality of sensing groups SG1 to SGn can result in unnecessary power consumption.

To address this issue, in an embodiment of the present disclosure, the input sensing device can be configured to perform scanning only for selected sensing units within the sensing group SG1 to SGn. The configuration and operation method of the input sensing device will be described in more detail below.

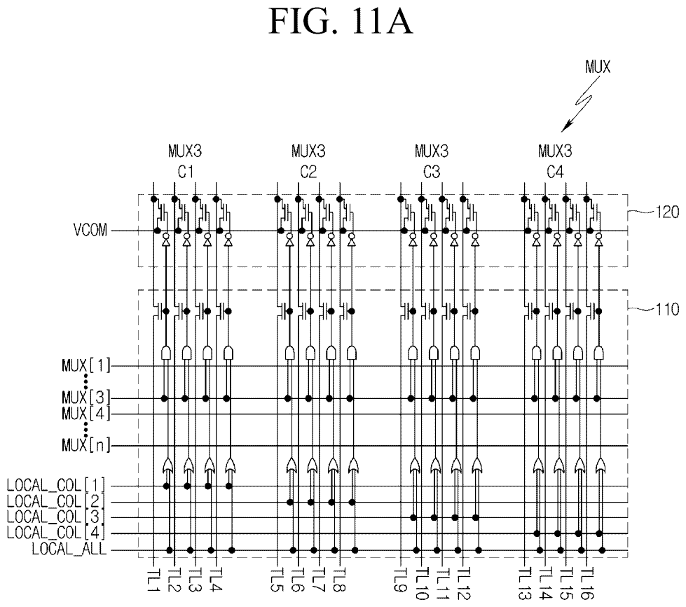

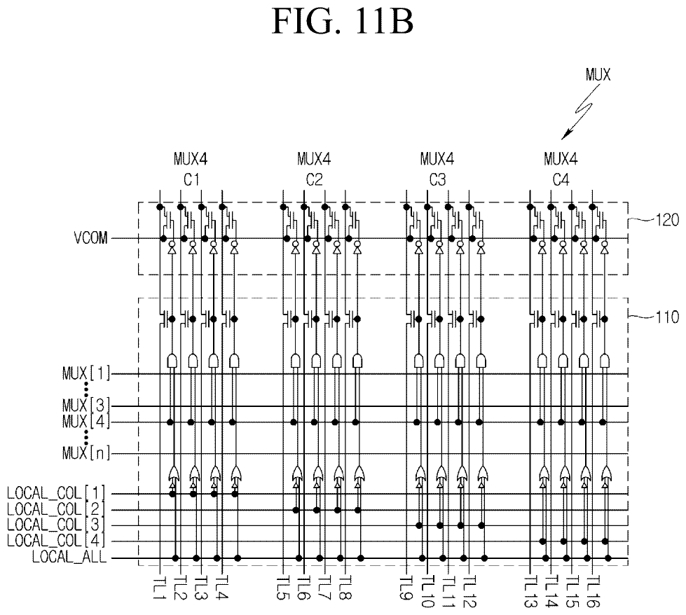

FIGS. 11A and 11B are diagrams illustrating the configuration of the multiplexer unit according to the first embodiment of the present disclosure. Here, FIGS. 11A and 11B illustrate the third multiplexer MUX3 and the fourth multiplexer MUX4, shown representatively for convenience of explanation.

Referring to FIGS. 4 and 11A-11B together, the multiplexer unit MUX according to the first embodiment includes a plurality of multiplexers MUX1 to MUXn. Each multiplexer MUX1 to MUXn can be connected to the touch electrodes TE within the corresponding sensing group SG1 to SGn through the touch lines TL1 to TL16. The number of touch lines TL1 to TL16 can correspond to the number of touch electrodes TE included in a single sensing group SG1 to SGn. For example, the third multiplexer MUX3 is connected to the first to sixteenth touch electrodes TE within the third sensing group SG3 through the first to sixteenth touch lines TL1 to TL16, and the fourth multiplexer MUX4 is connected to the first to sixteenth touch electrodes TE within the fourth sensing group SG4 through the first to sixteenth touch lines TL1 to TL16.

In an embodiment of the present disclosure, adjacent touch lines TL1 to TL16 can be connected to touch electrodes TE arranged in the same touch electrode columns C1 to C4. For example, the first to fourth touch lines TL1 to TL4 can be connected to the touch electrodes TE arranged in the first touch electrode column C1, the fifth to eighth touch lines TL5 to TL8 can be connected to the touch electrodes TE arranged in the second touch electrode column C2, the ninth to twelfth touch lines TL9 to TL12 can be connected to the touch electrodes TE arranged in the third touch electrode column C3, and the thirteenth to sixteenth touch lines TL13 to TL16 can be connected to the touch electrodes TE arranged in the fourth touch electrode column C4. However, this embodiment is not limited thereto.

Each multiplexer MUX1 to MUXn can include a first switching unit 110 and a second switching unit 120, which control the connection between the touch lines TL1 to TL16 and the touch driving circuit 20. Specifically, the first switching unit 110 controls the connection between the touch lines TL1 to TL16 and the touch driving circuit 20, while the second switching unit 120 controls the connection between the touch lines TL1 to TL16 and the common voltage Vcom.

The first switching unit 110 can receive the mux control signals MUX[1] to MUX[n] and the local selection signals as inputs. When the mux control signals MUX[1] to MUX[n] are at the turn-on level, the first switching unit 110 connects the touch electrodes TE corresponding to the local selection signal to the touch driving circuit 20.

The mux control signals MUX[1] to MUX[n] are applied through the respective mux control signal lines. Each mux control signal line is connected to the first switching unit 110 of the corresponding multiplexer MUX1 to MUXn, allowing the mux control signals MUX[1] to MUX[n] to be applied to the multiplexer MUX1 to MUXn. In the embodiment, the first switching unit 110 of the third multiplexer MUX3 receives the third mux control signal MUX[3], and the first switching unit 110 of the fourth multiplexer MUX4 receives the fourth mux control signal MUX[4].

The mux control signals MUX[1] to MUX[n] can be applied to turn on the corresponding multiplexers MUX1 to MUXn. The multiplexers MUX1 to MUXn turn on in response to the mux control signals MUX[1] to MUX[n] at the turn-on level and can electrically connect the sensing groups SG1 to SGn to the touch driving circuit 20. The multiplexers MUX1 to MUXn turn off in response to the mux control signals MUX[1] to MUX[n] at the turn-off level and can electrically separate the sensing groups SG1 to SGn from the touch driving circuit 20. In the embodiment, the third multiplexer MUX3 electrically connects the third sensing group SG3 to the touch driving circuit 20 when the third mux control signal MUX[3] is applied at the turn-on level, and the fourth multiplexer MUX4 electrically connects the fourth sensing group SG4 to the touch driving circuit 20 when the fourth mux control signal MUX[4] is applied at the turn-on level.

The local selection signal is applied to selectively connect sensing units SU1 to SU4 within the sensing groups SG1 to SGn to the touch driving circuit 20. In an embodiment of the present disclosure, each sensing unit SU1 to SU4 can be composed of a single touch electrode column C1 to C4, and the local selection signal can include local column signals LOCAL_COL[1] to LOCAL_COL[4] as local signals for connecting the respective touch electrode columns C to C4 to the touch driving circuit 20.

Each local column signal LOCAL_COL[1] to LOCAL_COL[4] corresponds to and indicates each of the touch electrode columns C1 to C4. Here, the number of local column signals LOCAL_COL[1] to LOCAL_COL[4] can correspond to the number of touch electrode columns C1 to C4 within a single sensing group SG1 to SGn. In the embodiment, when the sensing groups SG1 to SGn include four touch electrode columns C1 to C4, the local selection signal can include four local column signals LOCAL_COL[1] to LOCAL_COL[4].

In an embodiment of the present disclosure, the local selection signal can include a local all signal LOCAL_ALL that indicates all sensing units SU1 to SU4 within a sensing group SG1 to SGn. The local all signal LOCAL_ALL can be referred to herein as a local-all-signal LOCAL_ALL. The local all signal LOCAL_ALL can indicate whether all sensing units SU1 to SU4 are to be connected to the touch driving circuit 20 or only some of the sensing units SU1 to SU4 are to be connected to the touch driving circuit 20. When the local all signal LOCAL_ALL is at the turn-on level, it indicates that all sensing units SU1 to SU4 within a single sensing group SG1 to SGn are connected to the touch driving circuit 20, whereas when the local all signal LOCAL_ALL is at the turn-off level, it indicates that only a predetermined subset of sensing units within the sensing group is connected.

The first switching unit 110 can electrically connect the touch lines TL1 to TL16 to the touch driving circuit 20 through the logical operation of the multiplexer control signals MUX1 to MUXn and the local selection signals. Specifically, the first switching unit 110 can include at least one logic element and switching element to electrically connect the sensing unit SU1 to SU4 corresponding to the local selection signal to the touch driving circuit 20 when both the multiplexer control signal MUX1 to MUXn and the local selection signal are at the turn-on level (e.g., a logical high level).

For example, the first switching unit 110 can include first logic gates that determine whether the local selection signal is at the turn-on level, second logic gates that determine whether both the local selection signal and the multiplexer control signals MUX1 to MUXn are at the turn-on level, and switching elements that turn on when both the local selection signal and the multiplexer control signals MUX1 to MUXn are at the turn-on level to connect the touch lines TL1 to TL16 to the touch driving circuit 20.

In an embodiment of the present disclosure, the first logic gates can be OR gates. The OR gates can be electrically connected to the corresponding touch lines TL1 to TL16. Each OR gate can receive as input one of the corresponding local column signals LOCAL_COL1 to LOCAL_COL4 and the local all signal LOCAL_ALL.

For example, the OR gates connected to the first to fourth touch lines TL1 to TL4 can receive the first local column signal LOCAL_COL1 and the local all signal LOCAL_ALL as inputs. The OR gates connected to touch lines TL5 to TL8 can receive the second local column signal LOCAL_COL[2] and the local all signal LOCAL_ALL as inputs. The OR gates connected to touch lines TL9 to TL12 can receive the third local column signal LOCAL_COL[3] and the local all signal LOCAL_ALL as inputs. The OR gates connected to touch lines TL13 to TL16 can receive the fourth local column signal LOCAL_COL[4] and the local all signal LOCAL_ALL as inputs.

The OR gates can output a first logic signal at a logical high level (‘1’), when either the local selection signal or the local all signal LOCAL_ALL is at the turn-on level.

The second logic gates are connected to the outputs of the first logic gates. In one embodiment of the present disclosure, the second logic gates can be AND gates. The AND gates can be electrically connected to the corresponding touch lines TL1 to TL16. Each AND gate can receive as inputs the first logic signal output from the corresponding first logic gate and the corresponding mux control signals MUX[1] to MUX[n].

For example, the AND gates of the first switching unit 110 of the third multiplexer MUX3 can receive the first logic signal from the corresponding first logic gate and the third mux control signal MUX[3] as inputs. The AND gates of the first switching unit 110 of the fourth multiplexer MUX4 can receive the first logic signal from the corresponding first logic gate and the fourth mux control signal MUX[4] as inputs.

The AND gates can output a second logic signal at a logical high level when both the first logic signal and the mux control signal MUX[1] to MUX[n] are at the turn-on level, for example, a logical high level.

In one embodiment of the present disclosure, the switching elements can be transistors. Each transistor is connected between the corresponding touch line TL1 to TL16 and the touch driving circuit 20. The gate electrode of each transistor is connected to the output of the second logic gate. The transistor can turn on when the second logic gate outputs a second logic signal at a logical high level, thereby connecting the touch driving circuit 20 to the touch lines TL1 to TL16.

In an embodiment of the present disclosure, the transistor can be an n-type metal-oxide-semiconductor (NMOS) transistor. However, this embodiment is not limited thereto. In other embodiments, the transistor can be a p-type metal-oxide-semiconductor PMOS transistor. In such embodiments, the logic elements of the first switching unit 110 can be variously modified to invert the input signal of the switching element.

In one embodiment of the present disclosure, in any one of two adjacent multiplexers MUX1 to MUXn, the first switching unit 110 can further include first inverting logic gates. Here, the two adjacent multiplexers MUX1 to MUXn can be multiplexers adjacent in the row direction. For example, in the fourth multiplexer MUX4 among adjacent third and fourth multiplexers MUX3 and MUX4, the first switching unit 110 can further include first inverting logic gates.

In an embodiment of the present disclosure, the first inverting logic gates can be NOT gates. The NOT gates can receive corresponding local column signals LOCAL_COL[1] to LOCAL_COL[4] as inputs. The NOT gates can invert the logic level of the local column signals LOCAL_COL[1] to LOCAL_COL[4] and apply them to the input terminals of the first logic gates.

In the above-described embodiment, in response to a local all signal LOCAL_ALL at the turn-on level, all touch electrodes TE within a sensing group SG1 to SGn can be connected to the touch driving circuit 20 through the touch lines TL1 to TL16, while in response to a local all signal LOCAL_ALL at the turn-off level, only some touch electrodes TE within a plurality of adjacent sensing groups SG1 to SGn can be connected to the touch driving circuit 20 through the touch lines TL1 to TL16.

Additionally, in response to the first local column signal LOCAL_COL1 at the turn-on level, the first sensing unit SU1, i.e., the touch electrodes TE of the first touch electrode column C1, can be connected to the touch driving circuit 20 through the first to fourth touch lines TL1 to TL4. Similarly, in response to the second local column signal LOCAL_COL2 at the turn-on level, the second sensing unit SU2, for example, the touch electrodes TE of the second touch electrode column C2, can be connected to the touch driving circuit 20 through the fifth to eighth touch lines TL5 to TL8. In response to the third local column signal LOCAL_COL3 at the turn-on level, the third sensing unit SU3, for example, the touch electrodes TE of the third touch electrode column C3, can be connected to the touch driving circuit 20 through the ninth to twelfth touch lines TL9 to TL12. Likewise, in response to the fourth local column signal LOCAL_COL4 at the turn-on level, the fourth sensing unit SU4, for example, the touch electrodes TE of the fourth touch electrode column C4, can be connected to the touch driving circuit 20 through the thirteenth to sixteenth touch lines TL13 to TL16. Furthermore, in response to a local all signal LOCAL_ALL at the turn-on level, all touch electrodes TE arranged in the first to fourth touch electrode columns C1 to C4 can be connected to the touch driving circuit 20 through the touch lines TL1 to TL16.

Accordingly, the input sensing device can selectively connect some or all of the sensing units SU1 to SU4 within a sensing group SG1 to SGn to the touch driving circuit 20 based on the local all signal LOCAL_ALL and the local column signals LOCAL_COL1 to LOCAL_COL4. During a full scanning or pre-scanning, when the local all signal LOCAL_ALL is applied at the turn-on level, the input sensing device can scan all sensing units SU1 to SU4 in response to the local column signals LOCAL_COL1 to LOCAL_COL4 at the turn-on level. During local scanning, when the local all signal LOCAL_ALL is applied at the turn-off level, the input sensing device can scan only some sensing units SU1 to SU4 in response to the local column signals LOCAL_COL1 to LOCAL_COL4 at the turn-on level.

The second switching unit 120 can receive the second logic signal output from the first switching unit 110 and the common voltage Vcom as inputs. The second switching unit 120 electrically separates the common voltage Vcom and the touch lines TL1 to TL16 when the second logic signal is at the turn-on level, and electrically connects them when the second logic signal is at the turn-off level.

The second switching unit 120 can include at least one logic element and switching element. For example, the second switching unit 120 can include third logic gates that invert the logic level of the second logic signal and switching elements that turn on when the second logic signal is at a logic low level (‘0’) to apply the common voltage Vcom to the touch lines TL1 to TL16.

In an embodiment of the present disclosure, the third logic gates can be NOT gates. The NOT gates are each connected to the output terminals of the OR gates in the first switching unit 110. The NOT gates invert the logic level of the second logic signal output from the OR gates to output a third logic signal.

In an embodiment of the present disclosure, the switching devices can be transistors. Each transistor is connected between the corresponding touch line TL1 to TL16 and the common voltage Vcom, with its gate electrode connected to the output terminal of the third logic gate. The transistor is turned on when a logic high level third logic signal is output from the third logic gate, thereby connecting the touch line TL1 to TL16 to the common voltage Vcom.

In an embodiment of the present disclosure, the transistors can be NMOS transistors. However, this embodiment is not limited thereto. In other embodiments of the present disclosure, the transistor can be a p-type metal-oxide-semiconductor PMOS transistor. In such embodiments of the present disclosure, the logic devices in the second switching unit 120 can be modified in various ways to invert the input signal of the switching device. For example, the NOT gates in the second switching unit 120 can be omitted.

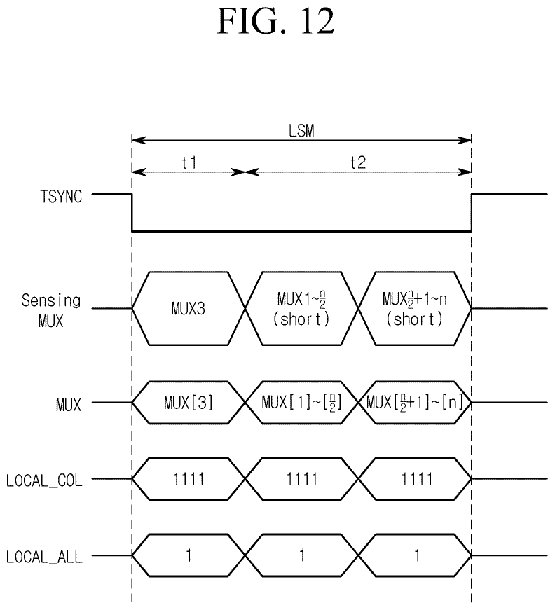

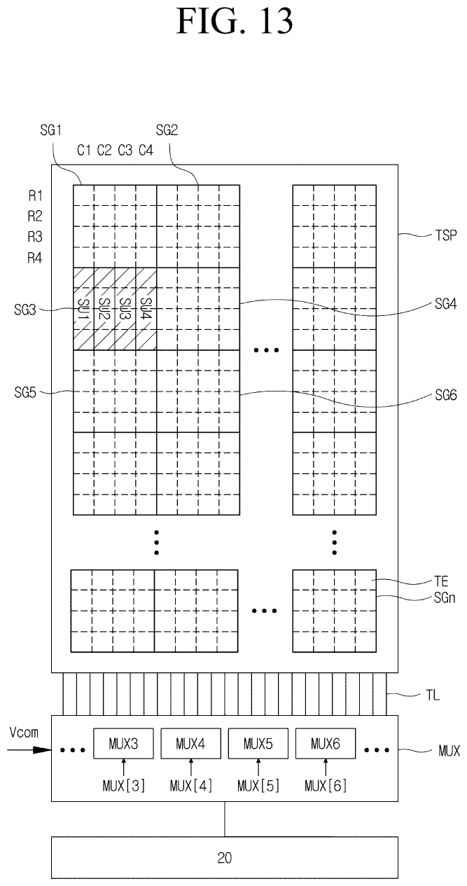

FIG. 12 is a timing diagram illustrating the driving signals of the multiplexer unit according to the embodiment of FIGS. 11A and 11B. FIG. 13 is a diagram illustrating the driving state of the touch panel according to the driving signals shown in FIG. 12.

As shown in FIG. 8, when a touch is detected in a sensing group SG1 to SGn, the input sensing device can perform a local scan for the corresponding sensing group SG1 to SGn. During the local scan, the multiplexers MUX1 to MUXn connected to the sensing group SG1 to SGn can connect all of the sensing units SU1 to SU4 within the corresponding sensing group SG1 to SGn to the touch driving circuit 20.

Referring to FIG. 12, when a touch occurs in the third sensing group SG3 as shown in FIG. 8, a local scan for the third sensing group SG3 can be performed during the first period t1 of the local scan mode LSM.

Specifically, during the t period t1, the third multiplexer MUX3 can receive the third mux control signal MUX[3] at the turn-on level. Additionally, since all sensing units SU1 to SU4 of the third sensing group SG3 need to be scanned during the first period t1, the local all signal LOCAL_ALL is applied as ‘1’, and the local column signals LOCAL_COL[1] to LOCAL_COL[4] are applied as ‘1111’.

As a result, through the first switching unit 110 of the third multiplexer MUX3, touch lines TL1 to TL16 are connected to the touch driving circuit 20, and ultimately, as shown in FIG. 13, the first to fourth sensing units SU1 to SU4 of the third sensing group SG3 are connected to the touch driving circuit 20. The touch driving circuit 20 applies the touch driving signal TDS to the first to fourth sensing units SU1 to SU4 and can sense a touch through the touch sensing signal.

During the second period t2 of the local scan mode LSM, a pre-scan for all sensing groups SG1 to SGn can be performed.

Specifically, during the second period t2, first, the first to n/2 multiplexers MUX1 to MUXn/2 can receive the turn-on level mux control signals MUX1 to MUXn/2. Additionally, during the local scan mode LSM, the local all signal LOCAL_ALL is applied at the ‘1’ level and the local column signals LOCAL_COL1 to LOCAL_COL4 are applied as ‘1111’.

Then, through the first switching unit 110 of the first to n/2-th multiplexers MUX1 to MUXn/2, the first to sixteenth touch lines TL1 to TL16 are connected to the touch driving circuit 20, and as a result, the first to n/2 sensing groups SG1 to SGn/2 are connected to the touch driving circuit 20. The touch driving circuit 20 applies the touch driving signal TDS to the first to n/2-th sensing groups SG1 to SGn/2 and can sense the touch through the touch sensing signal.

Afterward, the n/2+1 to nth multiplexers MUXn/2+1 to MUXn can receive the turn-on level mux control signals MUXn/2+1 to MUXn. Additionally, the local column signals LOCAL_COL1 to LOCAL_COL4 are applied as ‘1111’, and the local all signal LOCAL_ALL is applied at the ‘1’ level.

Then, through the first switching unit 110 of the n/2+1 to nth multiplexers MUXn/2+1 to MUXn, the first to sixteenth touch lines TL1 to TL16 are connected to the touch driving circuit 20, and as a result, the n/2+1 to nth sensing groups SGn/2+1 to SGn are connected to the touch driving circuit 20. The touch driving circuit 20 applies the touch driving signal TDS to the n/2+1 to nth sensing groups SGn/2+1 to SGn and can sense the touch through the touch sensing signal.

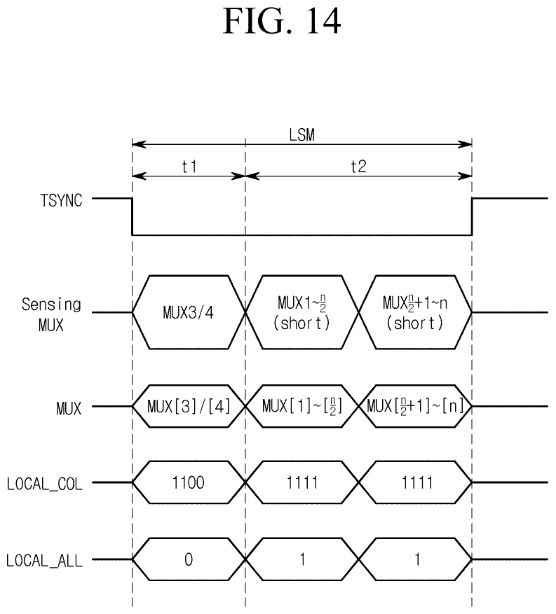

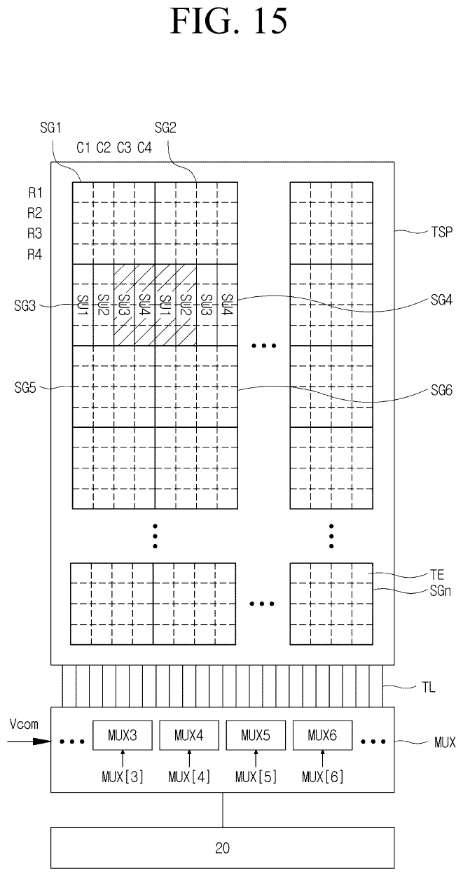

FIG. 14 is a timing diagram illustrating the driving signals of the multiplexer unit according to the embodiment of FIGS. 11A and 11B. FIG. 15 is a diagram illustrating the driving state of the touch panel according to the driving signals shown in FIG. 14.

As shown in FIG. 9, when a touch is detected in two or more adjacent sensing groups SG1 to SGn, the input sensing device can perform a local scan for the corresponding sensing groups SG1 to SGn. During the local scan, the multiplexers MUX1 to MUXn connected to the sensing groups SG1 to SGn can connect some or all of the sensing units SU1 to SU4 within the corresponding sensing group SG1 to SGn to the touch driving circuit 20.

With reference to FIG. 14, when a touch occurs in the third sensing group SG3 and the fourth sensing group SG4 adjacent to SG3 as shown in FIG. 9, a local scan for the third sensing group SG3 and the fourth sensing group SG4 can be performed during the first period t1 of the local scan mode LSM.

Specifically, during the first period t1, the third multiplexer MUX3 and the fourth multiplexer MUX4 can each receive the turn-on level third mux control signal MUX[3] and the turn-on level fourth mux control signal MUX[4]. Since some of the sensing units SU3 and SU4 in the third sensing group SG3 and some of the sensing units SU1 and SU2 in the fourth sensing group SG4 need to be scanned during the first period t1, the local all signal LOCAL_ALL can be applied at the ‘0’ level. Additionally, the local column signals LOCAL_COL[1] to LOCAL_COL[4] can be applied as ‘1100’, which is a combination of ‘11’ bits for scanning some of the sensing units SU1 and SU2 in the third sensing group SG3, and ‘00’ bits for scanning some of the sensing units SU3 and SU4 in the fourth sensing group SG4.

As a result, in response to the local all signal LOCAL_ALL at the logical low level and the logical high level of the third and fourth local column signals LOCAL_COL[3] and LOCAL_COL[4], the first switching unit 110 of the third multiplexer MUX3 can connect the ninth to sixteenth touch lines TL9 to TL16 to the touch driving circuit 20. As a result, the third and fourth sensing units SU3 and SU4 of the third sensing group SG3 are connected to the touch driving circuit 20 as shown in FIG. 15.

Furthermore, in response to the local all signal LOCAL_ALL at the logical low level and the first and second local column signals LOCAL_COL[1] and LOCAL_COL[2] at the logical low level, the first switching unit 110 of the fourth multiplexer MUX4 can connect the first to eighth touch lines TL1 to TL8 to the touch driving circuit 20. As a result, the first and second sensing units SU1 and SU2 of the fourth sensing group SG4 are connected to the touch driving circuit 20, as shown in FIG. 15.

The touch driving circuit 20 applies the touch driving signal TDS to the third and fourth sensing units SU3 and SU4 of the third sensing group SG3 and the first and second sensing units SU1 and SU2 of the fourth sensing group SG4 to sense the touch through the touch sensing signal.

During the second period t2 of the local scan mode LSM, a pre-scan for all sensing groups SG1 to SGn can be performed. The pre-scan driving method is the same as described with reference to FIG. 12.

The duration for scanning the four sensing units SU1 to SU4 included in the two sensing groups SG3 and SG4 in FIG. 14 can be the same as the duration for scanning the four sensing units SU1 to SU4 included in the one sensing group SG3 in FIG. 12. In this way, the input sensing device can sense the touch position with low power consumption at a fast speed during the local scan.

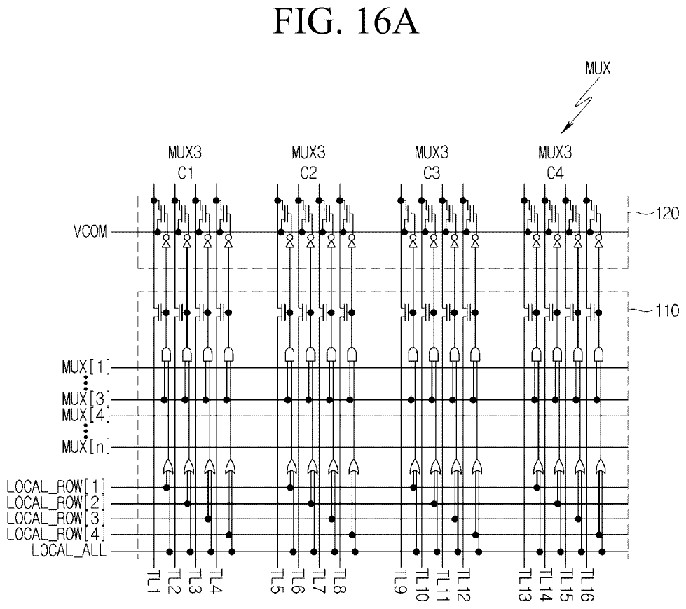

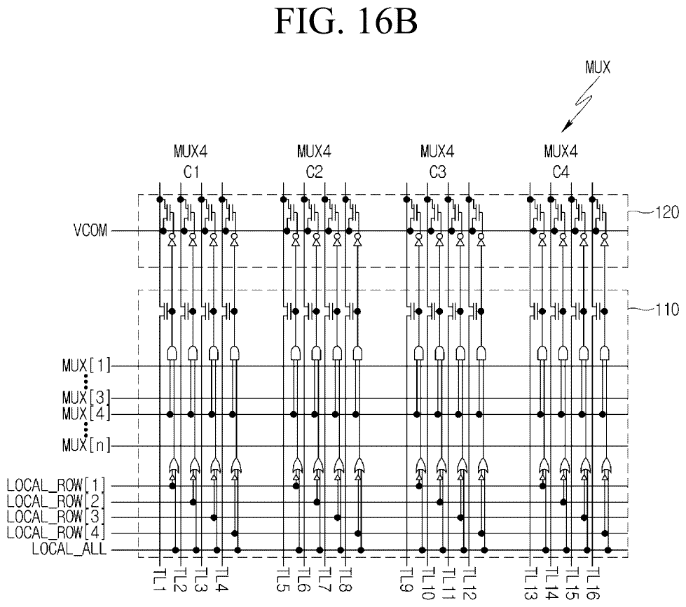

FIGS. 16A and 16B are diagrams illustrating the configuration of the multiplexer unit according to the second embodiment of the present disclosure. FIGS. 16A and 16B illustrate the third multiplexer MUX3 and the fourth multiplexer MUX4, shown representatively for convenience of explanation.

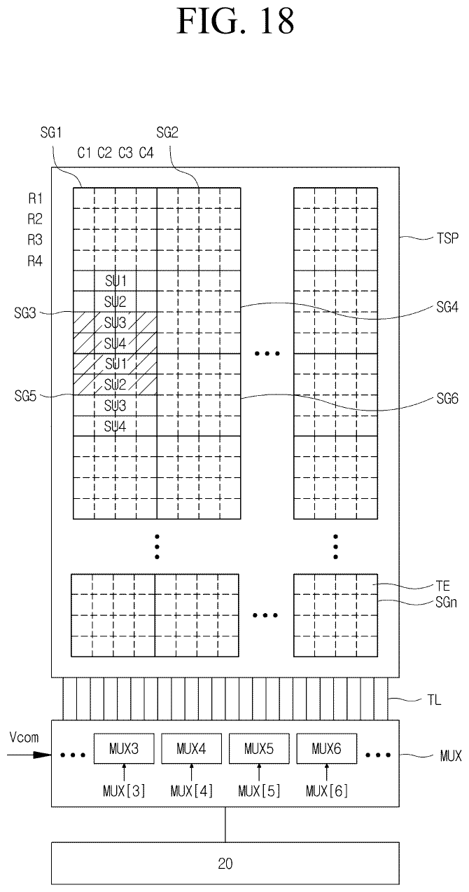

Compared to the embodiment of FIGS. 11A and 11B, in the embodiment of FIGS. 16A and 16B, each sensing unit (SU1 to SU4, FIG. 18) can be composed of a single touch electrode row (R1 to R4), and the local selection signal can include local row signals LOCAL_ROW[1] to LOCAL_ROW[4] for connecting each touch electrode row R1 to R4 to the touch driving circuit 20 as local signals.

Each local row signal LOCAL_ROW[1] to LOCAL_ROW[4] corresponds to each touch electrode row R1 to R4. In this case, the number of local row signals LOCAL_ROW[1] to LOCAL_ROW[4] can correspond to the number of touch electrode rows R1 to R4 in one sensing group SG1 to SGn. In the embodiment, when the sensing groups SG1 to SGn include four touch electrode rows R1 to R4, the local selection signal can include four local row signals LOCAL_ROW[1] to LOCAL_ROW[4].

The other components are the same as in the embodiment of FIGS. 11A and 11B.

In the above-described embodiment, in response to a local all signal LOCAL_ALL at the turn-on level, all touch electrodes TE within a sensing group SG1 to SGn can be connected to the touch driving circuit 20 through the touch lines TL1 to TL16, while in response to a local all signal LOCAL_ALL at the turn-off level, only some touch electrodes TE within a plurality of adjacent sensing groups SG1 to SGn can be connected to the touch driving circuit 20 through the touch lines TL1 to TL16.

Additionally, in response to the first local row signal LOCAL_ROW[1] at the turn-on level, the first sensing unit SU1, i.e., the touch electrodes TE in the first touch electrode row R1, can be connected to the touch driving circuit 20 through the first, fifth, ninth, and thirteenth touch lines TL1, TL5, TL9, and TL13. In response to the second local row signal LOCAL_ROW[2] at the turn-on level, the second sensing unit SU2, i.e., the touch electrodes TE in the second touch electrode row R2, can be connected to the touch driving circuit 20 through the second, sixth, tenth, and fourteenth touch lines TL2, TL6, TL10, and TL14. In response to the third local row signal LOCAL_ROW[3] at the turn-on level, the third sensing unit SU3, i.e., the touch electrodes TE in the third touch electrode row R3, can be connected to the touch driving circuit 20 through the third, seventh, eleventh, and fifteenth touch lines TL3, TL7, TL11, and TL15. In response to the fourth local row signal LOCAL_ROW[4] at the turn-on level, the fourth sensing unit SU4, i.e., the touch electrodes TE in the fourth touch electrode row R4, can be connected to the touch driving circuit 20 through the fourth, eighth, twelfth, and sixteenth touch lines TL4, TL8, TL12, and TL16. Furthermore, in response to the local all signal LOCAL_ALL at the turn-on level, all the touch electrodes TE arranged in the first to fourth touch electrode rows R1 to R4 can be connected to the touch driving circuit 20 through the touch lines TL1 to TL16.

Therefore, the input sensing device can selectively drive some or all of the sensing units SU1 to SU4 in the sensing groups SG1 to SGn through the local row signals LOCAL_ROW[1] to LOCAL_ROW[4]. During a full scan or pre-scan, the input sensing device can apply the local row signals LOCAL_ROW[1] to LOCAL_ROW[4] simultaneously at the turn-on level to scan all sensing units SU1 to SU4. During the local scan, the input sensing device can apply only some of the local row signals LOCAL_ROW[1] to LOCAL_ROW[4] at the turn-on level to scan only the selected sensing units SU1 to SU4.

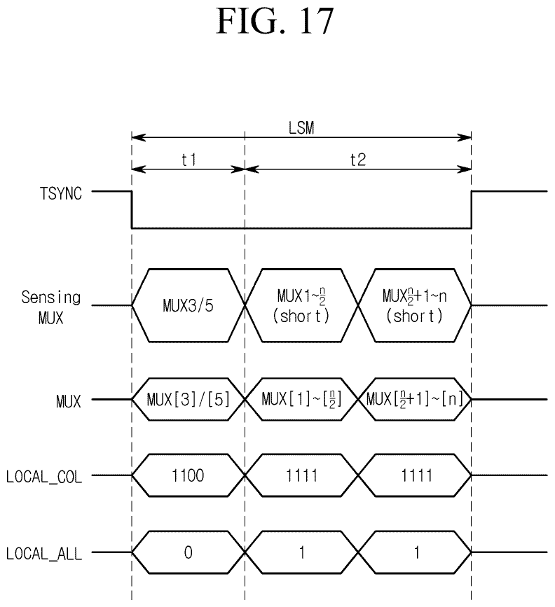

FIG. 17 is a timing diagram illustrating the driving signals of the multiplexer unit according to the embodiment of FIGS. 16A and 16B. FIG. 18 is a diagram illustrating the driving state of the touch panel according to the driving signals shown in FIG. 17.

When a touch is detected in two or more adjacent sensing groups SG1 to SGn, the input sensing device can perform a local scan for the corresponding sensing groups SG1 to SGn. During the local scan, the multiplexers MUX1 to MUXn connected to the sensing groups SG1 to SGn can connect some or all of the sensing units SU1 to SU4 within the corresponding sensing group SG1 to SGn to the touch driving circuit 20.

For example, when a touch is detected in the fourth sensing group SG4 adjacent to the third sensing group SG3 and the fifth sensing group SG5, a local scan for the third sensing group SG3 and the fifth sensing group SG5 can be performed during the first period t1 of the local scan mode LSM, as shown in FIG. 17.

Specifically, during the first period t1, the third mux control signal MUX[3] and the fifth mux control signal MUX[5] at the turn-on level can be applied to the third multiplexer MUX3 and the fifth multiplexer MUX5, respectively. Since some of the sensing units SU3 and SU4 of the third sensing group SG3 and some of the sensing units SU1 and SU2 of the fifth sensing group SG5 need to be scanned during the first period t1, the local all signal LOCAL_ALL can be applied at the ‘0’ level. Furthermore, the local column signals LOCAL_COL[1] to LOCAL_COL[4] can be applied as ‘1100’, which is a combination of ‘11’ bits for scanning some of the sensing units SU1 and SU2 in the third sensing group SG3, and ‘00’ bits for scanning some of the sensing units SU3 and SU4 in the fourth sensing group SG4.

In response to the local all signal LOCAL_ALL at the logical low level and the logical high level of the third and fourth local column signals LOCAL_COL[3] and LOCAL_COL[4], the touch lines TL3, TL4, TL7, TL8, TL11, TL12, TL15, and TL16 can be connected to the touch driving circuit 20 through the first switching unit 110 of the third multiplexer MUX3. As a result, the third and fourth sensing units SU3 and SU4 of the third sensing group SG3 are connected to the touch driving circuit 20 as shown in FIG. 18.

In response to the local all signal LOCAL_ALL at the logical low level and the third and fourth local column signals LOCAL_COL[3] and LOCAL_COL[4] at the logical low level, the first, second, fifth, sixth, ninth, tenth, thirteenth, and fourteenth touch lines TL1, TL2, TL5, TL6, TL9, TL10, TL13, and TL14 can be connected to the touch driving circuit 20 through the first switching unit 110 of the fourth multiplexer MUX4. As a result, the first and second sensing units SU1 and SU2 of the fourth sensing group SG4 are connected to the touch driving circuit 20, as shown in FIG. 18.

The touch driving circuit 20 applies the touch driving signal TDS to the third and fourth sensing units SU3 and SU4 of the third sensing group SG3 and the first and second sensing units SU1 and SU2 of the fifth sensing group SG5 to sense the touch through the touch sensing signal.

During the second period t2 of the local scan mode LSM, a pre-scan for all sensing groups SG1 to SGn can be performed. The pre-scan driving method is the same as described with reference to FIG. 12.

The duration for scanning the four sensing units SU1 to SU4 included in the two sensing groups SG3 and SG4 in FIG. 17 can be the same as the duration for scanning the four sensing units SU1 to SU4 included in the one sensing group SG3 in FIG. 12. In this way, the input sensing device can sense the touch position with low power consumption at a fast speed during the local scan.

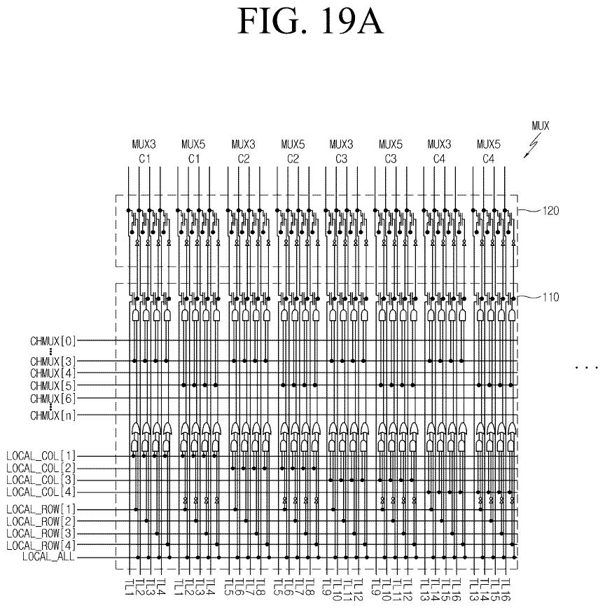

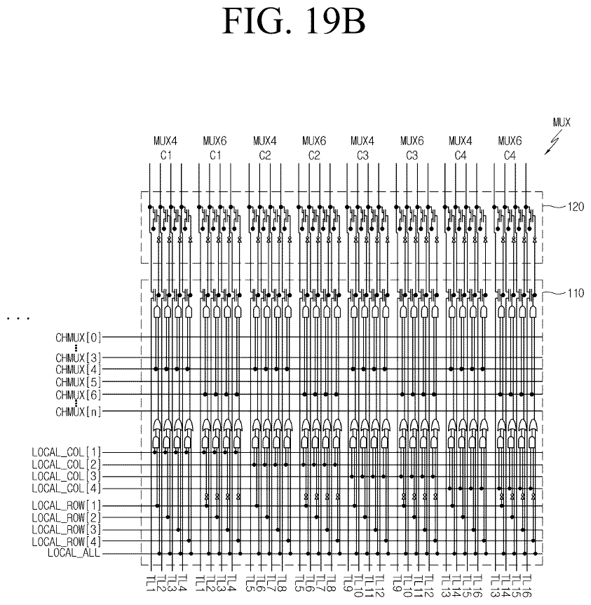

FIGS. 19A and 19B diagrams illustrating the configurations of the multiplexer unit according to the third embodiment of the present disclosure. FIGS. 19A and 19B illustrate the third to sixth multiplexers MUX3 to MUX6, shown representatively for convenience of explanation.

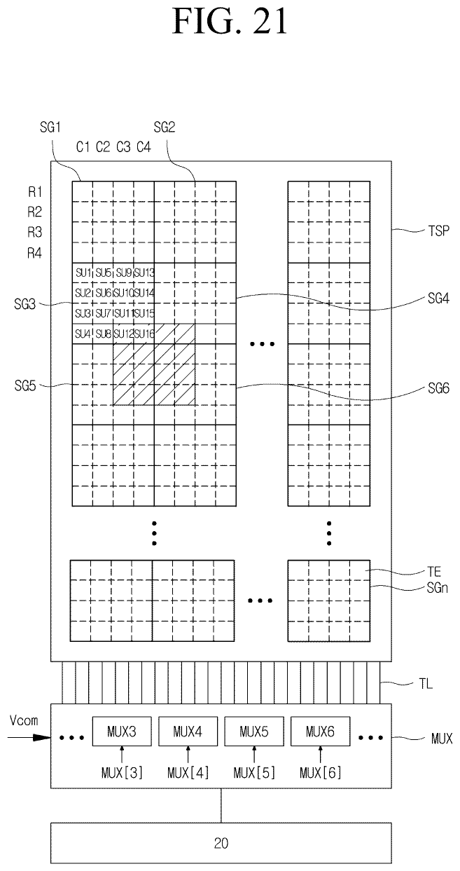

Compared to the embodiments of FIGS. 11A and 11B and FIGS. 16A and 16B, in the embodiment of FIGS. 19A and 19B, each sensing unit (SU1 to SU16, FIG. 21) can be composed of a single touch electrode TE, and the local selection signals can include local column signals LOCAL_COL[1] to LOCAL_COL[4] (first local signals) and local row signals LOCAL_ROW[1] to LOCAL_ROW[4] (second local signals) to connect each touch electrode TE to the touch driving circuit 20.

In this embodiment, the first switching unit 110 of each multiplexer MUX1 to MUXn can include first logic gates that determine whether the local selection signals are at the turn-on level, second logic gates that determine whether both the local selection signals and the mux control signals MUX[1] to MUX[n] are at the turn-on level, and switching elements that are turned on when both the local selection signals and mux control signals MUX[1] to MUX[n] are at the turn-on level, connecting the touch lines TL1 to TL16 to the touch driving circuit 20.

The first logic gates can include first-1 level logic gates to determine whether both the first local signal and second local signal are at the turn-on level, and first-2 logic gates to determine when the first local signal, second local signal, and local all signal are all at the turn-on level.

In an embodiment of the present disclosure, the first-1 level logic gates can be AND gates. The AND gates can be electrically connected to the corresponding touch lines TL1 to TL16. Each AND gate can receive one corresponding local column signal LOCAL_COL1 to LOCAL_COL4 and one corresponding local row signal LOCAL_ROW1 to LOCAL ROW4 as inputs.

For example, the AND gates connected to the first to fourth touch lines TL1 to TL4 can receive the first local column signal LOCAL_COL1 as input. Additionally, the AND gates connected to the first to fourth touch lines TL1 to TL4 can each receive one of the first to fourth local row signals LOCAL_ROW1 to LOCAL ROW4 as input.

The AND gates connected to the fifth to eighth touch lines TL5 to TL8 can receive the second local column signal LOCAL_COL2 as input. Additionally, the AND gates connected to the fifth to eighth touch lines TL5 to TL8 can each receive one of the first to fourth local row signals LOCAL_ROW1 to LOCAL ROW4 as input.

The AND gates connected to the ninth to twelfth touch lines TL9 to TL12 can receive the third local column signal LOCAL_COL3 as input. Additionally, the AND gates connected to the ninth to twelfth touch lines TL9 to TL12 can each receive one of the first to fourth local row signals LOCAL_ROW1 to LOCAL ROW4 as input.

The AND gates connected to the thirteenth to sixteenth touch lines TL13 to TL16 can receive the fourth local column signal LOCAL_COL4 as input. Additionally, the AND gates connected to the thirteenth to sixteenth touch lines TL13 to TL16 can each receive one of the first to fourth local row signals LOCAL_ROW1 to LOCAL ROW4 as input.

The AND gates can output a first-first logical signal at a logical high level when both the local column signals LOCAL_COL1 to LOCAL_COL4 and the local row signals LOCAL_ROW1 to LOCAL ROW4 are at the turn-on level, for example, at the logical high level.

The first-second logic gates are connected to the output terminals of the first-first logic gates. In an embodiment of the present disclosure, the first-second logic gates can be OR gates. The OR gates can be electrically connected to the corresponding touch lines TL1 to TL16. Each OR gate can receive the first-first logical signal output from the corresponding first-first logic gate and the local all signal LOCAL_ALL as inputs.

The OR gates can output a first-second logical signal at a logical high level when either the first-first logical signal or the local all signal LOCAL_ALL is at the turn-on level, for example, at the logical high level.

The second logic gates are connected to the output terminals of the first-second logic gates. In one embodiment of the present disclosure, the second logic gates can be AND gates. The AND gates can be electrically connected to the corresponding touch lines TL1 to TL16. Each AND gate can receive the first-second logic signal output from the corresponding first-second logic gate and the corresponding multiplexer control signals MUX[1] to MUX[n].

For example, the AND gates in the first switching unit 110 of the third multiplexer MUX3 can receive the first-second logic signal from the corresponding first-second logic gate and the third multiplexer control signal MUX[3]. Similarly, the AND gates in the first switching unit 110 of the fourth multiplexer MUX4 can receive the first-second logic signal from the corresponding first-second logic gate and the fourth multiplexer control signal MUX[4].

The AND gates can output the second logic signal at the logical high level when both the first-second logic signal and the multiplexer control signal MUX[1] to MUX[n] are at the turn-on level, for example, a logical high level.

In one embodiment of the present disclosure, the switching elements can be transistors. Each transistor is connected between the corresponding touch line TL1 to TL16 and the touch driving circuit 20. The gate electrode of each transistor is connected to the output of the second logic gate. The transistor can turn on when the second logic gate outputs a second logic signal at a logical high level, thereby connecting the touch driving circuit 20 to the touch lines TL1 to TL16.

In an embodiment of the present disclosure, the transistor can be an n-type metal-oxide-semiconductor (NMOS) transistor. However, this embodiment is not limited thereto. In other embodiments of the present disclosure, the transistor can be a p-type metal-oxide-semiconductor PMOS transistor. In such embodiments of the present disclosure, the logic elements of the first switching unit 110 can be variously modified to invert the input signal of the switching element.

In an embodiment of the present disclosure, among two adjacent multiplexers MUX1 to MUXn, the first switching unit 110 can further include second inversion logic gates. Here, the two adjacent multiplexers MUX1 to MUXn can be multiplexers adjacent in the column direction. For example, among the adjacent third and fifth multiplexers MUX3 and MUX5, in the fifth multiplexer MUX5, the first switching unit 110 can further include second inversion logic gates.

In an embodiment of the present disclosure, the second inversion logic gates can be NOT gates. The NOT gates can receive the corresponding local row signals LOCAL_ROW1 to LOCAL ROW4 as inputs. The NOT gates invert the logical levels of the local row signals LOCAL_ROW1 to LOCAL ROW4 and apply them to the input terminals of the first-first logic gates.

The other components are the same as in the embodiment of FIGS. 11A and 11B.

In the above-described embodiment, in response to a local all signal LOCAL_ALL at the turn-on level, all touch electrodes TE within a sensing group SG1 to SGn can be connected to the touch driving circuit 20 through the touch lines TL1 to TL16, while in response to a local all signal LOCAL_ALL at the turn-off level, only some touch electrodes TE within a plurality of adjacent sensing groups SG1 to SGn can be connected to the touch driving circuit 20 through the touch lines TL1 to TL16.

Additionally, in response to the first local column signal LOCAL_COL1 at the turn-on level and the first local row signal LOCAL_ROW1 at the turn-on level, the first sensing unit SU1, i.e., the first touch electrode, can be connected to the touch driving circuit 20 through the first touch line TL1. Additionally, in response to the first local column signal LOCAL_COL1 at the turn-on level and the second local row signal LOCAL ROW2 at the turn-on level, the second sensing unit SU2, i.e., the second touch electrode, can be connected to the touch driving circuit 20 through the second touch line TL2. Additionally, in response to the first local column signal LOCAL_COL1 at the turn-on level and the third local row signal LOCAL_ROW3 at the turn-on level, the third sensing unit SU3, i.e., the third touch electrode, can be connected to the touch driving circuit 20 through the third touch line TL3. Additionally, in response to the first local column signal LOCAL_COL1 at the turn-on level and the fourth local row signal LOCAL_ROW4 at the turn-on level, the fourth sensing unit SU4, i.e., the fourth touch electrode, can be connected to the touch driving circuit 20 through the fourth touch line TL4.

Therefore, the input sensing device can selectively drive some or all of the sensing units SU1 to SU4 in the sensing group SG1 to SGn through the local column signals LOCAL_COL1 to LOCAL_COL4 and local row signals LOCAL_ROW1 to LOCAL_ROW4. During a full scan or pre-scan, the input sensing device can apply the local column signals LOCAL_COL1 to LOCAL_COL4 and local row signals LOCAL_ROW1 to LOCAL_ROW4 simultaneously at the turn-on level to scan all sensing units SU1 to SU4. During local scan, the input sensing device can apply some of the local column signals LOCAL_COL1 to LOCAL_COL4 and some of the local row signals LOCAL_ROW1 to LOCAL_ROW4 at the turn-on level to scan only the selected sensing units SU1 to SU4.

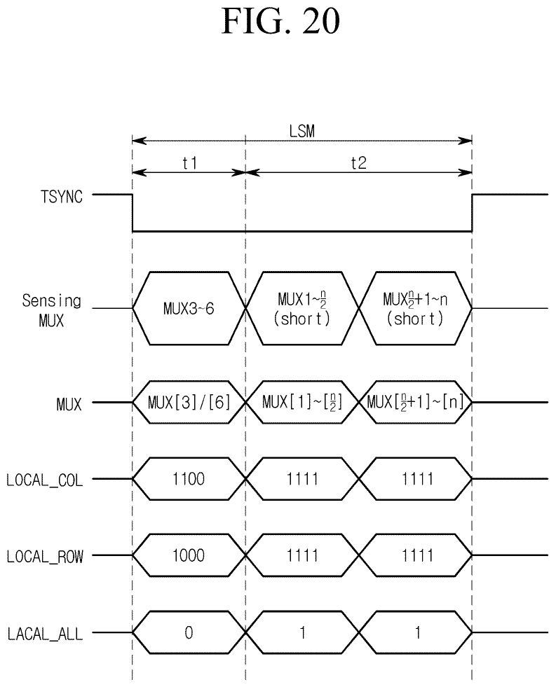

FIG. 20 is a timing diagram illustrating the driving signals of the multiplexer unit according to the embodiment of FIGS. 19A and 19B. FIG. 21 is a diagram illustrating the driving state of the touch panel according to the driving signals shown in FIG. 20.

When a touch is detected in two or more adjacent sensing groups SG1 to SGn as shown in FIG. 10, the input sensing device can perform a local scan for the respective sensing groups SG1 to SGn. During the local scan, the multiplexers MUX1 to MUXn connected to the sensing groups SG1 to SGn can connect some or all of the sensing units SU1 to SU4 within the corresponding sensing group SG1 to SGn to the touch driving circuit 20.

With reference to FIG. 20, when a touch is detected in adjacent third to sixth sensing groups SG3 to SG6 as shown in FIG. 10, local scan for the third to sixth sensing groups SG3 to SG6 can be performed during the first period t1 of the local scan mode LSM.

Specifically, during the first period t1, the third to sixth MUX control signals MUX[3] to MUX[6] at the turn-on level can be applied to the third to sixth multiplexers MUX3 to MUX6, respectively. Since some of the sensing units SU1 to SU16 in the third to sixth sensing groups SG3 to SG6 need to be scanned during the first period t1, the local all signal LOCAL_ALL can be applied at the ‘0’ level. Additionally, the local column signals LOCAL_COL[1] to LOCAL_COL[4] can be applied as ‘1100’, which is a combination of ‘11’ bits for scanning the third and fourth touch electrode columns C3 and C4 of the third sensing group SG3 and the fifth sensing group SG5, and ‘00’ bits for scanning the first and second touch electrode columns C1 and C2 of the fourth sensing group SG4 and the sixth sensing group SG6. The local row signals LOCAL_ROW[1] to LOCAL_ROW[4] can be applied as ‘1000’, which is a combination of ‘1’ bit for scanning the fourth touch electrode row R4 of the third sensing group SG3 and the fourth sensing group SG4, and ‘000’ bits for scanning the first to third touch electrode rows R1 to R3 of the fifth sensing group SG5 and the sixth sensing group SG6.

Then, in response to the logic low level of the local all signal LOCAL_ALL, the third and fourth local column signals LOCAL_COL[3] and LOCAL_COL[4] at the logic high level, and the fourth local row signal LOCAL_ROW[4] at the logic high level, the 12th and 16th touch lines TL12 and TL16 can be connected to the touch driving circuit 20 through the first switching unit 110 of the third multiplexer MUX3.

Additionally, in response to the local all signal LOCAL_ALL at the logic low level, the first and second local column signals LOCAL_COL[1] and LOCAL_COL[2] at the logic low level, and the fourth local row signal LOCAL_ROW[4] at the logic high level, the fourth and eighth touch lines TL4 and TL8 can be connected to the touch driving circuit 20 through the first switching unit 110 of the fourth multiplexer MUX4.

Additionally, in response to the local all signal LOCAL_ALL at the logic low level, the third and fourth local column signals LOCAL_COL[3] and LOCAL_COL[4] at the logic high level, and the first to third local row signals LOCAL_ROW[1] to LOCAL_ROW[3] at the logic low level, the 9th, 10th, 11th, 13th, 14th, and 15th touch lines TL9, TL10, TL11, TL13, TL14, and TL15 can be connected to the touch driving circuit 20 through the first switching unit 110 of the fifth multiplexer MUX5.

Additionally, in response to the local all signal LOCAL_ALL at the logic low level, the first and second local column signals LOCAL_COL[1] and LOCAL_COL[2] at the logic low level, and the first to third local row signals LOCAL_ROW[1] to LOCAL_ROW[3] at the logic low level, the 1st, 2nd, 3rd, 5th, 6th, and 7th touch lines TL1, TL2, TL3, TL5, TL6, and TL7 can be connected to the touch driving circuit 20 through the first switching unit 110 of the sixth multiplexer MUX6.

The touch driving circuit 20 can apply the touch driving signal TDS to the touch electrodes TE of the third to sixth sensing groups SG3 to SG6 to sense a touch through the touch sensing signals.

During the second period t2 of the local scan mode LSM, a pre-scan for all sensing groups SG1 to SGn can be performed. The pre-scan driving method is the same as described with reference to FIG. 12.

In FIG. 20, the duration of the period for scanning the sensing units included in the four sensing groups SG3 to SG6 can be the same as the duration of the period for scanning the four sensing units SU1 to SU4 included in one sensing group SG3, as shown in FIG. 12. In this way, the input sensing device can sense the touch position with low power consumption at a fast speed during the local scan.

The input sensing device and the display device including the same, according to the embodiments of the present disclosure, are advantageous for minimizing or reducing touch sensing in unnecessary areas where no touch input occurs by selectively driving only the touch electrodes corresponding to the touch position when a touch input is detected.

The input sensing device and the display device including the same, according to the embodiments of the present disclosure, are advantageous sensing time and lowering power consumption.

The input sensing device and the display device including the same, according to the embodiments of the present disclosure, are advantageous for efficiently and freely selecting and controlling the area for sensing touch input during local scan mode.

Although embodiments of this disclosure have been described above with reference to the accompanying drawings, it will be understood that the technical configuration of this disclosure described above can be implemented in other specific forms by those skilled in the art without changing the technical concept or essential features of the present disclosure. Therefore, it should be understood that the embodiments described above are examples and not limited in all respects. Furthermore, the scope of the present disclosure is defined by the claims set forth below, rather than the detailed description above. In addition, it should be understood that all modifications or variations derived from the meaning and scope of the claims and their equivalent concept are included within the scope of this disclosure.

What is claimed is:

1. An input sensing device comprising:
a touch panel comprising a plurality of touch electrodes divided into a plurality of sensing groups;
a touch driving circuit configured to apply a touch driving signal to the plurality of sensing groups during a touch driving period, and sense a touch based on a touch sensing signal received in response to the touch driving signal; and
a plurality of multiplexers connected to corresponding sensing group through a plurality of touch lines, and configured to electrically connect the corresponding sensing group to the touch driving circuit in response to a multiplexer control signal and a local selection signal,
wherein each of the plurality of sensing groups comprises a plurality of sensing units including one or more touch electrodes, and
wherein each of the plurality of multiplexers is configured to electrically connect all or some of the plurality of sensing units of the corresponding sensing group to the touch driving circuit in response to the local selection signal during the touch driving period.

2. The input sensing device of claim 1, wherein each of the plurality of multiplexers comprises:
a first switching unit configured to control a connection between the plurality of touch lines and the touch driving circuit based on the multiplexer control signal and the local selection signal; and
a second switching unit configured to control a connection between a common voltage and the touch lines based on an output signal of the first switching unit.

3. The input sensing device of claim 2, wherein the first switching unit comprises:
first logic gates configured to output a first logic signal at a logic high level based on the local selection signal being at a turn-on level;
second logic gates configured to output a second logic signal at a logic high level based on both the first logic signal and the multiplexer control signal being at a turn-on level; and
switching elements configured to be turned on and electrically connect a corresponding touch line to the touch driving circuit based on the second logic signal being at a logic high level.

4. The input sensing device of claim 3, wherein the local selection signal comprises:
a plurality of local signals indicating each of the plurality of sensing units; and
a local-all-signal indicating all of the plurality of sensing units.

5. The input sensing device of claim 4, wherein each of the first logic gates is an OR gate configured to receive a corresponding local signal and the local-all-signal, and output the first logic signal at a logic high level based on at least one of the corresponding local signal and the local-all-signal being at the turn-on level.

6. The input sensing device of claim 4, wherein, in one of two multiplexers respectively connected to two adjacent sensing groups, the first switching unit further comprises first inverting logic gates configured to invert the logic level of the corresponding local signal and apply the inverted logic level to the first logic gates.

7. The input sensing device of claim 4, wherein the plurality of local signals comprise at least one of a plurality of local column signals each indicating one or more touch electrode columns and a plurality of local row signals each indicating one or more touch electrode rows.

8. The input sensing device of claim 7, wherein the first logic gates comprise:
first-first logic gates configured to output a first-first logic signal at a logic high level based on both the corresponding local row signal and the corresponding local column signal being at the turn-on level; and
first-second logic gates configured to output a first-second logic signal at a logic high level based on both the first-first logic signal and the local-all-signal being at the turn-on level.

9. The input sensing device of claim 8, wherein each of the first-first logic gates is an AND gate configured to receive the corresponding local row signal and the corresponding local column signal, and output the first-first logic signal at a logic high level based on both the corresponding local row signal and the corresponding local column signal being at the turn-on level.

10. The input sensing device of claim 8, wherein, in one of two multiplexers connected to two adjacent sensing groups, the first switching unit further comprises second inverting logic gates configured to invert a logic level of the corresponding local row signal and apply the inverted logic level to the first-first logic gates.

11. The input sensing device of claim 8, wherein each of the first-second logic gates is an OR gate configured to receive the first-first logic signal and the local-all-signal, and output the first-second logic signal at a logic high level based on at least one of the first-first logic signal and the local-all-signal being at the turn-on level.

12. The input sensing device of claim 3, wherein each of the second logic gates is an AND gate configured to receive the first logic signal and the multiplexer control signal, and output the second logic signal at a logic high level based on both the first logic signal and the multiplexer control signal being at the turn-on level.

13. The input sensing device of claim 3, wherein each of the switching elements is a transistor connected between the corresponding touch line and the touch driving circuit and each of the switching elements comprises a gate electrode configured to receive the second logic signal.

14. The input sensing device of claim 4, wherein, in a full scan mode, the multiplexer control signals at the turn-on level are sequentially applied to the plurality of multiplexers, and
in a local scan mode, the multiplexer control signal at the turn-on level is applied to at least one multiplexer corresponding to the sensed touch.

15. The input sensing device of claim 14, wherein, based on the touch being sensed in one sensing group, the local-all-signal at the turn-on level is further applied to the multiplexer connected to the one sensing group in the local scan mode.

16. The input sensing device of claim 14, wherein, based on the touch being sensed in two or more adjacent sensing groups, the local-all-signal at a turn-off level is further applied to the multiplexers connected to the two or more adjacent sensing groups, and the local signal at a turn-on level is further applied to at least one sensing unit where the touch is sensed.

17. A display device comprising:
a display panel comprising a plurality of pixels;
a data driving circuit configured to apply a data voltage to the plurality of pixels;
a scan driving circuit configured to apply gate signals to the plurality of pixels;
a timing controller configured to control operation timings of the data driving circuit and the scan driving circuit;
a touch panel overlapping the display panel, and comprising touch electrodes divided into a plurality of sensing groups;
a touch driving circuit configured to apply a touch driving signal to the plurality of sensing groups during a touch driving period, and sense a touch based on a touch sensing signal received in response to the touch driving signal; and
a plurality of multiplexers connected to corresponding sensing group through a plurality of touch lines and configured to electrically connect the corresponding sensing groups to the touch driving circuit in response to multiplexer control signals and local selection signals,
wherein each of the plurality of sensing groups comprises a plurality of sensing units including one or more touch electrodes, and
wherein each of the plurality of multiplexers is configured to electrically connect all or some of the plurality of sensing units of the corresponding sensing group to the touch driving circuit in response to the local selection signal during the touch driving period.

18. The display device of claim 17, wherein each of the plurality of multiplexers comprises:
a first switching unit configured to control a connection between the plurality of touch lines and the touch driving circuit based on the multiplexer control signal and the local selection signal; and
a second switching unit configured to control a connection between a common voltage and the touch lines based on an output signal of the first switching unit.

19. The display device of claim 18, wherein the first switching unit comprises:
first logic gates configured to output a first logic signal at a logic high level based on the local selection signal being at a turn-on level;
second logic gates configured to output a second logic signal at a logic high level based on both the first logic signal and the multiplexer control signal being at a turn-on level; and
switching elements configured to be turned on and electrically connect a corresponding touch line to the touch driving circuit based on the second logic signal being at a logic high level.

20. The display device of claim 19, wherein the local selection signal comprises:
a plurality of local signals indicating respective ones of the plurality of sensing units; and
a local-all-signal indicating all of the plurality of sensing units.
